(19) United States
(12) Patent Application Publication
(10) Pub. No.: US 2010/0157127 A1
(43) Pub. Date: Jun. 24, 2010

(54) Image Display Apparatus and Image Sensing Apparatus

(75) Inventors: Wataru TAKAYANAGI, Ashiya City (JP); Tomoko OKU, Osaka (JP)

Correspondence Address: HOGAN & HARTSON L.L.P., 1999 AVENUE OF THE STARS, SUITE 1400, LOS ANGELES, CA, 90067, US

(73) Assignee: SANYO ELECTRIC CO., LTD., Osaka (JP)

(21) Appl. No.: 12/638,774

(22) Filed: Dec. 15, 2009

(30) Foreign Application Priority Data
Dec. 18, 2008 (JP) 2008-322221

(51) Int. Cl. H04N 5/222

(52) U.S. Cl. 348/333.02; 348/E05.022

(57) ABSTRACT

An image display apparatus includes a subject distance detection portion which detects a subject distance of each subject whose image is taken by an image taking portion, an output image generating portion which generates an image in which a subject positioned within a specific distance range is in focus as an output image from an input image taken by the image taking portion, and a display controller which extracts an in-focus region that is an image region in the output image in which region the subject positioned within the specific distance range appears based on a result of the detection by the subject distance detection portion, and controls a display portion to display a display image based on the output image so that the in-focus region can be visually distinguished.

### CROSS-REFERENCE TO RELATED APPLICATIONS

This nonprovisional application claims priority under 35 U.S.C. §119(a) on Patent Application No. 2008-322221 filed in Japan on Dec. 18, 2008, the entire contents of which are hereby incorporated by reference.

### BACKGROUND OF THE INVENTION

1. Field of the Invention

The present invention relates to an image display apparatus which display an image based on a taken image and an image sensing apparatus including the image display apparatus.

2. Description of Related Art

In an image sensing apparatus such as a digital camera having an automatic focus function, automatic focus control is usually performed optically so that a subject within an automatic focus (AF) area becomes in focus, and after that an actual shooting process is performed. A result of the automatic focus control can be checked in many cases on a display screen provided to the image sensing apparatus. However, in this method, it is difficult to understand which part in the AF area is in focus because the display screen of the image sensing apparatus is small. Therefore, a user may misunderstand the region that is actually in focus.

In view of this point, a conventional image sensing apparatus performs a control based on a contrast detection method as described below, for a purpose of easily confirming which region is actually in focus.

An image region of a taken image is divided into a plurality of blocks, and an AF score is determined for each block while moving a focus lens. Further, a total AF score that is a sum of AF scores of all blocks in the AF area is calculated for each lens position of the focus lens. Then, the lens position at which the total AF score becomes largest is derived as an in-focus lens position. On the other hand, a lens position for maximize the AF score of the block is detected as a block in-focus lens position for each block. Then, the block having a small difference between the in-focus lens position and the corresponding block in-focus lens position is decided to be a focused region (in-focus region), and the region is displayed.

However, this conventional method requires multi-step movement of the focus lens, so that time necessary for taking an image increases. In addition, the conventional method cannot be used in the case where the lens is not moved for taking an image.

In addition, a user wants to obtain a taken image in which a noted subject is in focus, but the noted subject may be out of focus in an actually taken image. It is beneficial if an image in which a desired subject is in focus can be obtained from a taken image after the taken image is obtained.

### SUMMARY OF THE INVENTION

A first image display apparatus according to the present invention includes a subject distance detection portion which detects a subject distance of each subject whose image is taken by an image taking portion, an output image generating portion which generates an image in which a subject positioned within a specific distance range is in focus as an output image from an input image taken by the image taking portion, and a display controller which extracts an in-focus region that is an image region in the output image in which region the subject positioned within the specific distance range appears based on a result of the detection by the subject distance detection portion, and controls a display portion to display a display image based on the output image so that the in-focus region can be visually distinguished.

Specifically, for example, the subject distance detection portion detects a subject distance of a subject at each position on the input image based on image data of the input image and characteristics of an optical system of the image taking portion, and the output image generating portion receives designation of the specific distance range, and performs image processing on the input image corresponding to the subject distance detected by the subject distance detection portion, the designated specific distance range, and the characteristics of the optical system of the image taking portion so as to generate the output image.

More specifically, for example, the image data of the input image contains information based on the subject distance of the subject at each position on the input image, and the subject distance detection portion extracts the information from the image data of the input image, and detects the subject distance of the subject at each position on the input image based on a result of the extraction and the characteristics of the optical system.

Alternatively and specifically, for example, the subject distance detection portion extracts a predetermined high frequency component contained in each of a plurality of color signals representing the input image, and detects the subject distance of the subject at each position on the input image based on a result of the extraction and characteristics of axial chromatic aberration of the optical system.

A first image sensing apparatus according to the present invention includes an image taking portion and the first image display apparatus described above.

In addition, for example, in the image sensing apparatus according to the present invention, image data obtained by imaging with the image taking portion is supplied to the first image display apparatus as the image data of the input image. After taking the input image, the output image is generated from the input image in accordance with an operation of designating the specific distance range, so that the display image based on the output image is displayed on the display portion.

A second image display apparatus according to the present invention includes an image obtaining portion which obtains image data of an input image that is image data containing subject distance information based on a subject distance of each subject, a specific subject distance input portion which receives an input of a specific subject distance, and an image generation and display controller portion which generates an output image in which a subject positioned at the specific subject distance is in focus by performing image processing on the input image based on the subject distance information, and controls a display portion to display the output image or an image based on the output image.

Further, for example, the image generation and display controller portion specifies the subject that is in focus in the output image, and controls the display portion to display with emphasis on the subject that is in focus.

A second image sensing apparatus according to the present invention includes an image taking portion and the second image display apparatus described above.

Meanings and effects of the present invention will be apparent from the following description of embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is a schematic general block diagram of an image sensing apparatus according to a first embodiment of the present invention.

FIGS. 2A and 2B are diagrams illustrating examples of an original image and a target focused image, respectively, which are obtained by the image sensing apparatus illustrated in FIG. 1.

FIGS. 3A to 3D are diagrams illustrating examples of an emphasis display image obtained by the image sensing apparatus illustrated in FIG. 1.

FIG. 4 is a diagram illustrating a luminance adjustment example when the emphasis display image is generated according to the first embodiment of the present invention.

FIG. 5 is a flowchart illustrating a flow of an operation of the image sensing apparatus illustrated in FIG. 1.

FIG. 6 is a diagram illustrating characteristics of axial chromatic aberration of a lens according to a second embodiment of the present invention.

FIGS. 7A to 7C are diagrams illustrating positional relationships among a point light source, a lens with axial chromatic aberration, an image formation point of each color light and an image sensor according to the second embodiment of the present invention, in which FIG. 7A illustrates the case where a distance between the point light source and the lens is relatively small, FIG. 7B illustrates the case where the distance between the point light source and the lens is a medium value, an FIG. 7C illustrates the case where the distance between the point light source and the lens is relatively large.

FIG. 8 is a diagram illustrating a positional relationship among the point light source, the lens with axial chromatic aberration and the image sensor, as well as divergences of images of individual color light on the image sensor according to the second embodiment of the present invention.

FIG. 9 is a diagram illustrating resolution characteristics of color signals of an original image obtained through the lens with axial chromatic aberration according to the second embodiment of the present invention.

FIG. 10 is a diagram illustrating resolution characteristics of color signals of the original image obtained through the lens with axial chromatic aberration according to the second embodiment of the present invention.

FIG. 11 is a general block diagram of the image sensing apparatus according to the second embodiment of the present invention.

FIGS. 12A to 12D are diagrams illustrating a principle of generation of a target focused image from an original image via an intermediate image according to the second embodiment of the present invention.

FIG. 13 is a diagram illustrating two subject distances (D₁ and D₂) according to a concrete example of a second embodiment of the present invention.

FIG. 14 is a diagram illustrating two subjects at two subject distances (D₁ and D₂), and images of the two subjects on the original image.

FIG. 15 is an internal block diagram of a high frequency component extraction and distance detection portion, and a depth of field expansion processing portion illustrated in FIG. 11.

FIG. 16 is a diagram illustrating a meaning of a pixel position on the original image, the intermediate image and the target focused image.

FIG. 17 is a diagram illustrating characteristic of a value generated by the high frequency component extraction and distance detection portion illustrated in FIG. 15.

FIG. 18 is a diagram illustrating a subject distance estimation method performed by the high frequency component extraction and distance detection portion illustrated in FIG. 15.

FIG. 19 is an internal block diagram of a depth of field control portion illustrated in FIG. 11.

FIG. 20 is a diagram illustrating contents of a process performed by the depth of field control portion illustrated in FIG. 19.

FIG. 21 is a diagram illustrating contents of a process performed by the depth of field control portion illustrated in FIG. 19.

FIG. 22 is an internal block diagram of a depth of field adjustment portion that can be used instead of the depth of field expansion processing portion and the depth of field control portion illustrated in FIG. 11.

FIG. 23 is a diagram illustrating contents of a process performed by the depth of field adjustment portion illustrated in FIG. 22.

FIG. 24 is a variation internal block diagram of the depth of field adjustment portion illustrated in FIG. 22.

FIG. 25 is a schematic general block diagram of the image sensing apparatus according to the first embodiment of the present invention, in which an operation portion and a depth information generating portion are added to FIG. 1.

### DETAILED DESCRIPTION OF THE PREFERRED EMBODIMENTS

Hereinafter, some embodiments of the present invention will be described concretely with reference to the attached drawings. In the individual diagrams, the same portions are denoted by the same reference numerals so that overlapping description thereof will be omitted as a general rule.

### First Embodiment

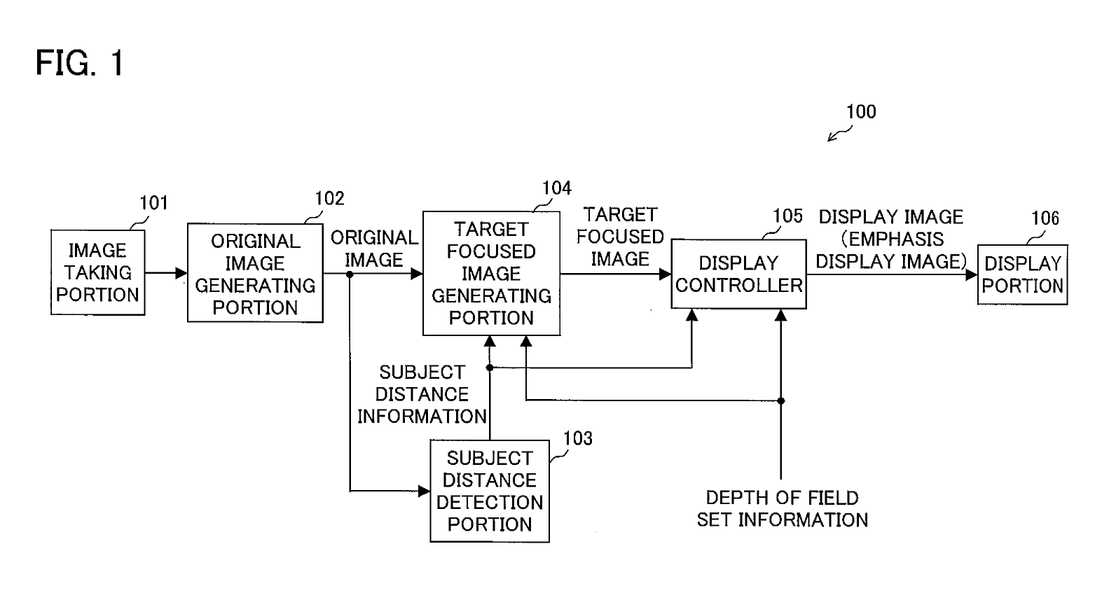

First, a first embodiment of the present invention will be described. FIG. 1 is a schematic general block diagram of an image sensing apparatus 100 according to a first embodiment. The image sensing apparatus 100 (and other image sensing apparatuses of other embodiments that will be described later) is a digital still camera that can take and record still images or a digital video camera that can take and record still images and moving images. The image sensing apparatus 100 includes individual portions denoted by numerals 101 to 106. Note that “image taking” and “image sensing” have the same meaning in this specification.

The image taking portion 101 includes an optical system and an image sensor such as a charge coupled device (CCD), and delivers an electric signal representing an image of a subject when a image is taken with the image sensor. The original image generating portion 102 generates image data by performing predetermined image signal processing on an output signal of the image taking portion 101. One still image represented by the image data generated by the original image generating portion 102 is referred to as an original image. The original image represents a subject image formed on the image sensor of the image taking portion 101. Note that the image data is data indicating a color and intensity of an image.

The image data of the original image contains information depending on a subject distance of a subject in each pixel position in the original image. For instance, axial chromatic aberration of the optical system of the image taking portion 101 causes the image data of the original image to contain such information (this information will be described in another embodiment). The subject distance detection portion 103 extracts the information from the image data of the original image, and detects (estimates) a subject distance of a subject at each pixel position in the original image based on a result of the extraction. The information representing a subject distance of a subject at each pixel position in the original image is referred to as subject distance information. Note that a subject distance of a certain subject is a distance between the subject and the image sensing apparatus (image sensing apparatus 100 in the present embodiment) in a real space.

A target focused image generating portion 104 generates image data of a target focused image based on the image data of the original image, the subject distance information and depth of field set information. The depth of field set information is information that specifies a depth of field of a target focused image to be generated by the target focused image generating portion 104. Based on the depth of field set information, a shortest subject distance and a longest subject distance within the depth of field of the target focused image are specified. A depth of field specified by the depth of field set information will be simply referred to as a specified depth of field as well. The depth of field set information is set by a user's operation, for example.

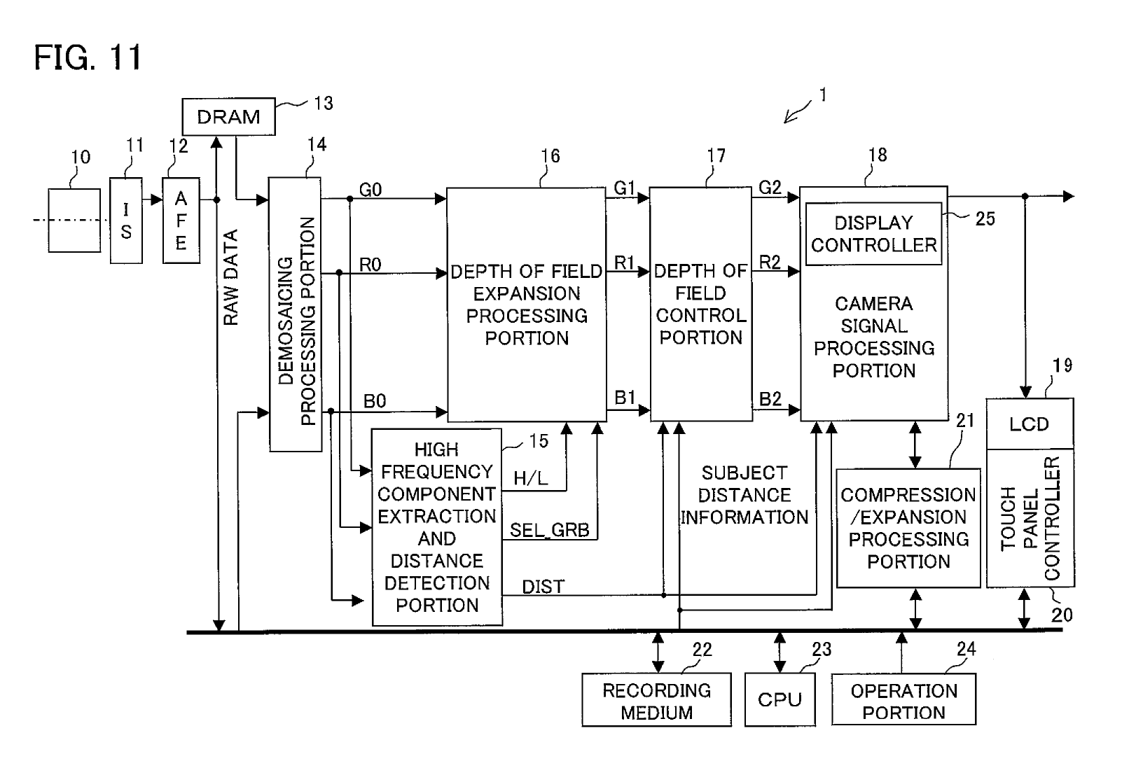

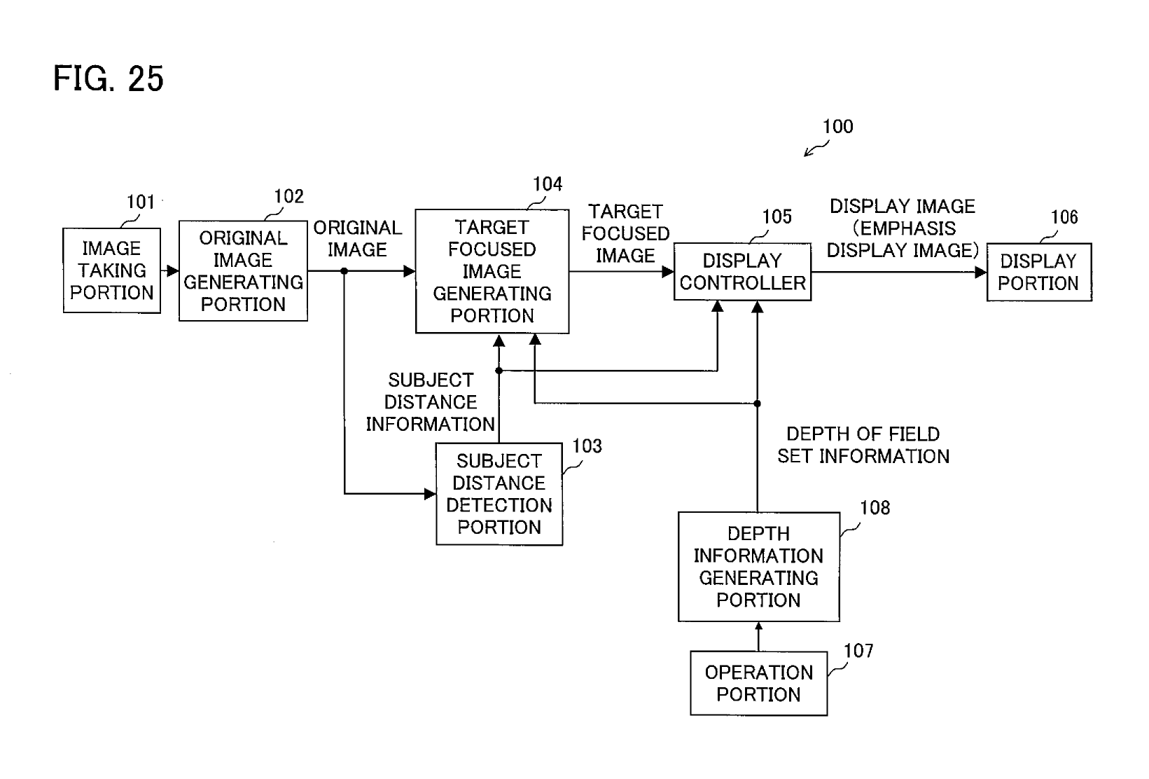

In other words, specifically, for example, the user can set a specified depth of field arbitrarily by a predetermined setting operation to an operation portion 107 in the image sensing apparatus 100 (see FIG. 25; operation portion 24 in an image sensing apparatus 1 illustrated in FIG. 11). In FIG. 25, a depth information generating portion 108 provided to the image sensing apparatus 100 recognizes the specified depth of field from contents of the setting operation so as to generate the depth of field set information. The user can set the specified depth of field by inputting the shortest subject distance and the longest subject distance in the operation portion 107 (or the operation portion 24 in the image sensing apparatus 1 of FIG. 11). The user can also set the specified depth of field by inputting the shortest, the medium or the longest subject distance within the depth of field of the target focused image and a value of the depth of field of the target focused image in the operation portion 107 (or the operation portion 24 in the image sensing apparatus 1 of FIG. 11). Therefore, it can be said that the operation portion 107 in the image sensing apparatus 100 (or the operation portion 24 in the image sensing apparatus 1 of FIG. 11) functions as the specific subject distance input portion.

The target focused image is an image in which a subject positioned within the specified depth of field is in focus while a subject positioned outside the specified depth of field is out of focus. The target focused image generating portion 104 performs image processing on the original image in accordance with the subject distance information based on the depth of field set information, so as to generate the target focused image having the specified depth of field. The method of generating the target focused image from the original image will be exemplified in another embodiment. Note that being in focus has the same meaning as “being focused”.

A display controller 105 generates image data of a special display image based on the image data of the target focused image, the subject distance information and the depth of field set information. This special display image is called an emphasis display image for convenience sake. Specifically, based on the subject distance information and the depth of field set information, an image region that is in focus in the entire image region of the target focused image is specified as an in-focus region, and a predetermined modifying process is performed on the target focused image so that the in-focus region can be visually distinguished from other image region on the display screen of the display portion 106. The target focused image after the modifying process is displayed as the emphasis display image on a display screen of the display portion 106 (such as an LCD). Note that the image region that is out of focus in the entire image region of the target focused image is referred to as an out-of-focus region.

A subject positioned at a subject distance within the specified depth of field is referred to as a focused subject, and a subject at a subject distance outside the specified depth of field is referred to as a non-focused subject. Image data of a focused subject exists in the in-focus region of the target focused image as well as the emphasis display image, and image data of a non-focused subject exists in the out-of-focus region of the target focused image as well as the emphasis display image.

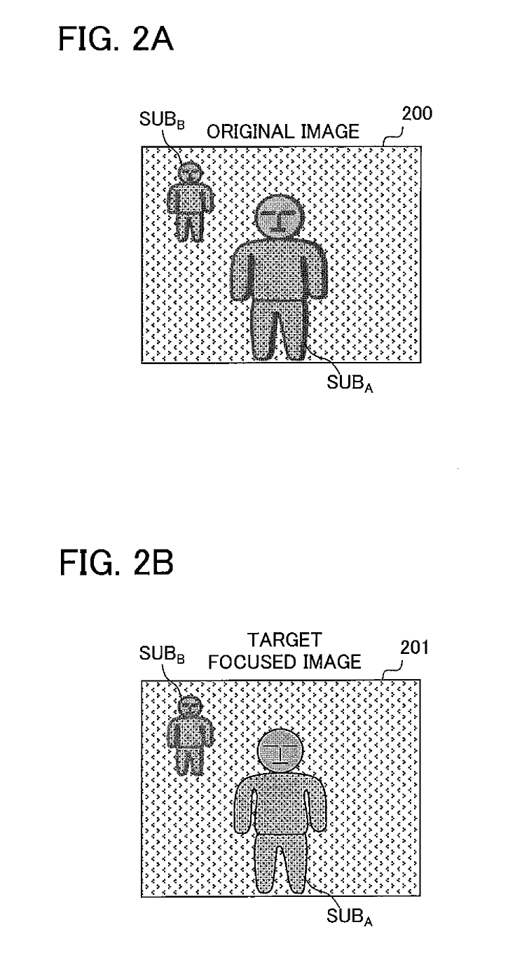

Examples of the original image, the target focused image and the emphasis display image will be described. An image 200 in FIG. 2A illustrates an example of an original image. The original image 200 is obtained by taking an image of real space region including subjects SUB_{A} and SUB_{B} that are human figures. A subject distance of the subject SUB_{A} is smaller than that of the subject SUB_{B}. In addition, the original image 200 illustrated in FIG. 2A is an original image under the condition supposing that an optical system of the image taking portion 101 has relatively large axial chromatic aberration. Because of the axial chromatic aberration, the subjects SUB_{A} and SUB_{B} in the original image 200 are blurred.

A image 201 illustrated in FIG. 2B is an example of a target focused image based on the original image 200. When the target focused image 201 is generated, it is supposed that the depth of field set information is generated so that a subject distance of the subject SUB_{A} is within the specified depth of field, while a subject distance of the subject SUB_{B} is outside the specified depth of field. Therefore, the subject SUB_{A} is clear while the subject SUB_{B} is blurred in the target focused image 201.

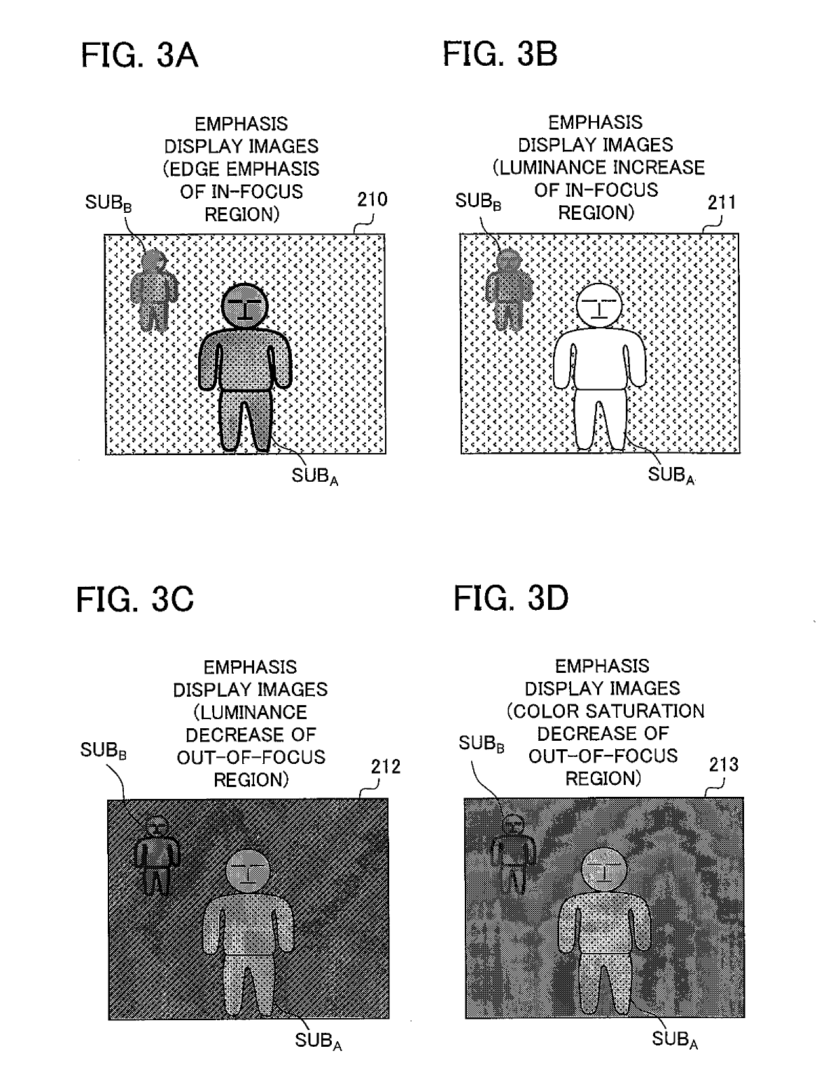

As described above, the display controller 105 obtains the emphasis display image by processing the target focused image so that the in-focus region can be visually distinguished on the display screen of the display portion 106. Each of images 210 to 213 illustrated in FIGS. 3A to 3D are examples of the emphasis display image based on the target focused image 201. The image region in which the image data of the subject SUB_{A} exists in the target focused image 201 is included in the in-focus region. Actually, the image region in which image data of a peripheral subject of the subject SUB_{A} (e.g., the ground beneath the subject SUB_{A}) exists is also included in the in-focus region, but it is supposed here that the image region of all subjects except the subject SUB_{A} are included in the out-of-focus region in the emphasis display images 210 to 213, for avoiding complicated illustration and for simple description.

For instance, as illustrated in FIG. 3A, the in-focus region can be visually distinguished by emphasizing edges of the image in the in-focus region of the target focused image 201. In this case, edges of the subject SUB_{A} are emphasized in the obtained emphasis display image 210. Emphasis of the edge can be realized by a filtering process using a well-known edge emphasizing filter. FIG. 3A illustrates the manner in which edges of the subject SUB_{A} are emphasized by thicken the contour of the subject SUB_{A}.

Alternatively, for example, as illustrated in the emphasis display image 211 of FIG. 3B, a modifying process of increasing luminance (or brightness) of the image in the in-focus region is performed on the target focused image 201, so that the in-focus region can be visually distinguished. In this case, the subject SUB_{A} is brighter than others in the obtained emphasis display image 211.

Alternatively, for example, as illustrated in the emphasis display image 212 of FIG. 3C, a modifying process of decreasing luminance (or brightness) of the images in the out-of-focus region is performed on the target focused image 201, so that the in-focus region can be visually distinguished. In this case, subjects except the subject SUB_{A} is dark in the obtained emphasis display image 212. Note that it is possible to perform a modifying process of increasing luminance (or brightness) of the image in the in-focus region while decreasing luminance (or brightness) of images in the out-of-focus region on the target focused image 201.

Alternatively, for example, as illustrated in the emphasis display image 213 of FIG. 3D, a modifying process of decreasing color saturation of the images in the out-of-focus region is performed on the target focused image 201, so that the in-focus region can be visually distinguished. In this case, color saturation of the image within the in-focus region is not changed. However, it is possible to increase color saturation of the image within the in-focus region.

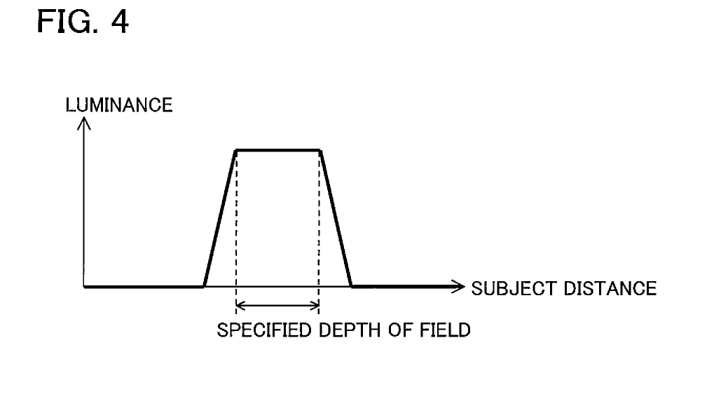

Note that when luminance of images in the out-of-focus region is to be decreased, it is possible to decrease luminance of the images in the out-of-focus region uniformed by substantially the same degree. However, it is also possible to change the degree of decreasing luminance so as to increase gradually along with the subject distance of the image region having the decreasing luminance becoming distant from the center of the specified depth of field as illustrated in FIG. 4. The same is true for the case in which brightness or color saturation is decreased. Also in the edge emphasis, the degree of the edge emphasis is not required to be uniform. For instance, it is possible to decrease the degree of the edge emphasis gradually along with the subject distance of the image region in which the edge emphasis is performed being distant from the center of the specified depth of field.

In addition, it is possible to perform a combination of a plurality of modifying processes among the above-mentioned modifying processes. For instance, it is possible to adopt a modifying process of decreasing luminance (or brightness) of images in the out-of-focus region while emphasizing edges of the image within the in-focus region. The methods described above for displaying so that the in-focus region can be visually distinguished are merely examples, and any other method can be adopted as long as the in-focus region can be visually distinguished on a display portion 16.

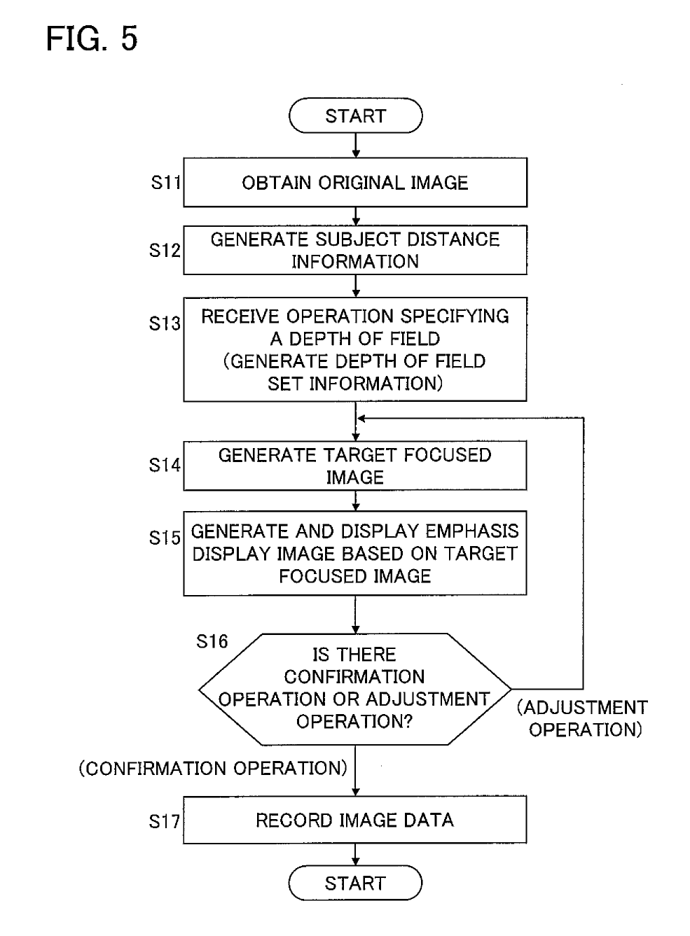

FIG. 5 illustrates a flow of an operation of the image sensing apparatus 100. First, in Step S11, an original image is obtained. In the next Step S12, subject distance information is generated from image data of the original image. After that, in Step S13, the image sensing apparatus 100 receives a user's operation of specifying a depth of field, and generates depth of field set information in accordance with the specified depth of field. In the next Step S14, image data of the target focused image is generated from the image data of the original image by using the subject distance information and the depth of field set information. Further, in Step S15, the emphasis display image based on the target focused image is generated and is displayed.

In the state where the emphasis display image is displayed, a separation process of Step S16 is performed. Specifically, in Step S16, the image sensing apparatus 100 receives a user's confirmation operation or adjustment operation. The adjustment operation is an operation for changing the specified depth of field.

In Step S16, if the user did the adjustment operation, the depth of field set information is changed in accordance with the specified depth of field changed by the adjustment operation, and after that, the process of Steps S14 and S15 is performed again. In other words, the image data of the target focused image is generated from the image data of the original image again in accordance with the changed depth of field set information, and the emphasis display image based on the new target focused image is generated and is displayed. After that, user's confirmation operation or adjustment operation is received again.

On the other hand, if the user did the confirmation operation in Step S16, the image data of the target focused image, from which the currently displayed emphasis display image is generated, is compressed and is recorded in the recording medium (not shown) in Step S17.

According to the image sensing apparatus 100 (and other image sensing apparatuses of other embodiments that will be described later), it is possible to generate the target focused image having an arbitrary depth of field in which an arbitrary subject is in focus after taking the original image. In other words, focus control after taking an image can be performed, so that a failure in taking an image due to focus error can be avoided.

When a user wants to generate a image in which a desired subject is in focus by the focus control after taking the image, there will be some cases where it is difficult to know which subject is in focus because of a relatively small display screen provided to the image sensing apparatus. In view of this, the apparatus of the present embodiment generates the emphasis display image in which the image region being in focus (focused subject) can be visually distinguished. Thus, the user can easily recognize which subject is in focus, so that the image in which a desired subject is in focus can be obtained securely and easily. In addition, since the in-focus region is specified by using the distance information, the user can be informed of the in-focus region precisely.

### Second Embodiment

A second embodiment of the present invention will be described. In the second embodiment, the method of generating the target focused image from the original image will be described in detail, and a detailed structure and an operational example of the image sensing apparatus according to the present invention will be described.

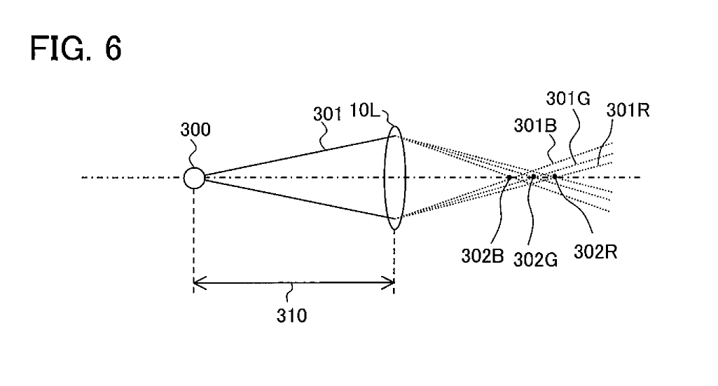

With reference to FIGS. 6, 7A to 7C and 8, characteristics of a lens 10L that are used in the image sensing apparatus of the second embodiment will be described. The lens 10L has a predetermined axial chromatic aberration that is relatively large. Therefore, as illustrated in FIG. 6, a light beam 301 directed from a point light source 300 to the lens 10L is separated by the lens 10L into a blue color light beam 301B, a green color light beam 301G and a red color light beam 301R. The blue color light beam 301B, the green color light beam 301G and the red color light beam 301R form images at different image formation points 302B, 302G and 302R. The blue color light beam 301B, the green color light beam 301G and the red color light beam 301R are respectively blue, green and red components of the light beam 301.

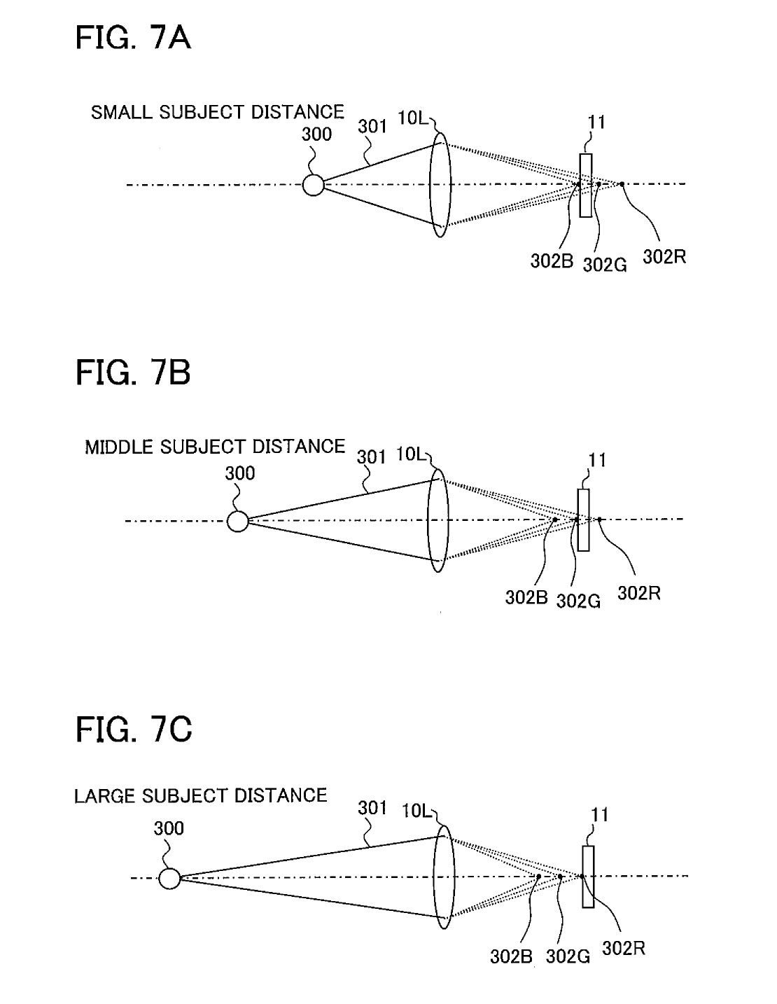

In FIG. 7A and others, numeral 11 denotes an image sensor that is used in the image sensing apparatus. The image sensor 11 is a solid state image sensor such as a charge coupled device (CCD) or a complementary metal oxide semiconductor (CMOS) image sensor. The image sensor 11 is a so-called single plate image sensor. On the front surface of each of light receiving pixels of one image sensor as the image sensor 11, there is disposed one of filters including a red filter that transmits only a red light component, a green filter that transmits only a green light component and a blue filter that transmits only a blue light component. The arrangement of the red filters, the green filters and the blue filters is the Bayer arrangement.

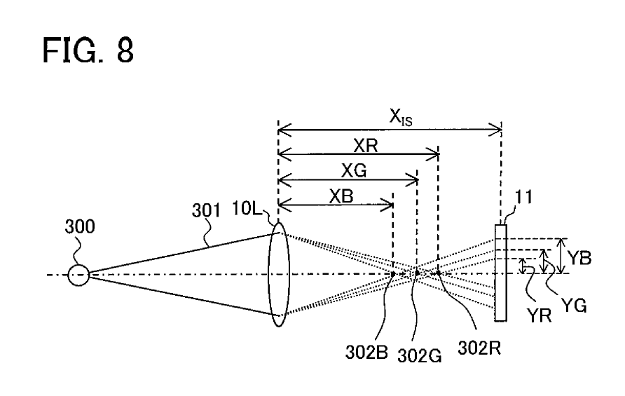

Distances from the center of the lens 10L to the image formation points 302B, 302G and 302R are respectively denoted by XB, XG and XR as illustrated in FIG. 8. Then, because of axial chromatic aberration of the lens 10L, an inequality “XB<XG<XR” holds. In addition, a distance from the center of the lens 10L to the image sensor 11 is denoted by X_{IS}. An inequality “XB<XG<XR<X_{IS}” holds in FIG. 8, but a magnitude relationship among the distances XB, XG, XR and X_{IS} changes when a distance 310 between a light source 300 and the center of the lens 10L (see FIG. 6) changes. If the point light source 300 is regarded as a noted subject, the distance 310 is a subject distance of the noted subject.

FIGS. 7A to 7C illustrate a manner in which positions of image formation points 302B, 302G and 302R are changes when the distance 310 changes. FIG. 7A illustrates a positional relationship among the image formation points 302B, 302G and 302R and the image sensor 11 when the distance 310 is relatively small so that “XB=X_{IS}” holds. FIG. 7B illustrates a positional relationship among the image formation points 302B, 302G and 302R and the image sensor 11 when the distance 310 increases from the state of FIG. 7A so that “XG=X_{IS}” holds. FIG. 7C illustrates a positional relationship among the image formation points 302B, 302G and 302R and the image sensor 11 when the distance 310 further increases from the state of FIG. 7B so that “XR=X_{IS}” hold.

The position of the lens 10L when the distance X_{IS} corresponds to the distance XB, XG or XR is the in-focus position of the lens 10L with respect to the blue color light beam 301B, the green color light beam 301G or the red color light beam 301R, respectively. Therefore, when “XB=X_{IS}”, “XG=X_{IS}” or “XR=X_{IS}” holds, the image sensor 11 can obtain an image in focus completely with respect to the blue color light beam 301B, the green color light beam 301G or the red color light beam 301R, respectively. However, in the image that is in focus completely with respect to the blue color light beam 301B, images of the green color light beam 301G and the red color light beam 301R are blurred. The same is true for the image that is in focus completely with respect to the green color light beam 301G or the red color light beam 301R. In FIG. 8, YB, YG and YR respectively denote radii of images of the blue color light beam 301B, the green color light beam 301G and the red color light beam 301R, which are formed on an imaging surface of the image sensor 11.

Characteristics of the lens 10L including a characteristic of axial chromatic aberration are known in advance when the image sensing apparatus is designed, and the image sensing apparatus can naturally recognize the distance X_{IS}, too. Therefore, if the distance 310 is known, the image sensing apparatus can estimate blur states of the images of the blue color light beam 301B, the green color light beam 301G and the red color light beam 301R by using the characteristics of the lens 10L and the distance X_{IS}. In addition, if the distance 310 is known, point spread functions of the images of the blue color light beam 301B, the green color light beam 301G and the red color light beam 301R are determined. Therefore, using the inverse functions of the point spread functions, it is possible to remove the blur of the images. Note that it is possible to change the distance X_{IS}, but it is supposed that the distance X_{IS} is fixed to be a constant distance in the following description for simple description, unless otherwise noted.

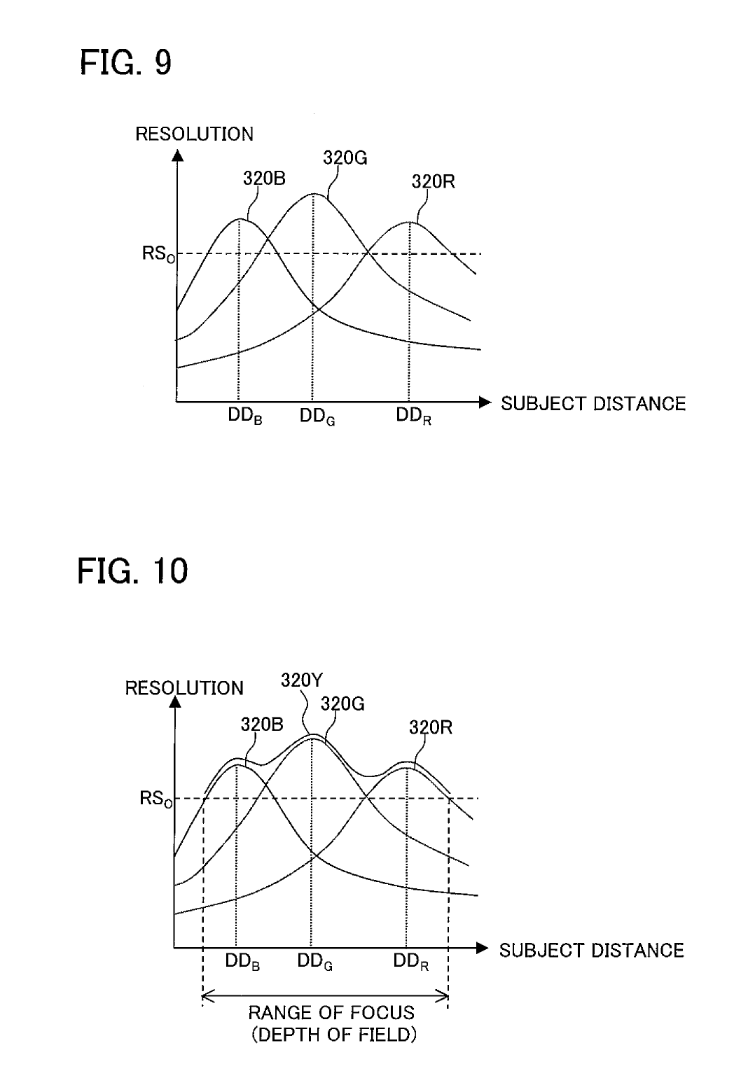

FIG. 9 illustrates a relationship among the subject distance, resolutions of B, G and R signals of the original image obtained from the image sensor 11. Here, the original image means an image obtained by performing a demosaicing process on RAW data obtained from the image sensor 11 and corresponds to an original image generated by a demosaicing processing portion 14 that will be described later (see FIG. 11 and the like). The B, G and R signals respectively mean a signal representing a blue color component in the image corresponding to the blue color light beam 301B, a signal representing a green color component in the image corresponding to the green color light beam 301G and a signal representing a red color component in the image corresponding to the red color light beam 301R.

Note that the resolution in this specification means not the number of pixels of a image but a maximum spacial frequency that can be expressed in the image. In other words, the resolution in this specification means a scale indicating the extent to which the image can reproduce finely, which is also referred to as a resolving power.

In FIG. 9, curves 320B, 320G and 320R respectively indicate dependencies of resolutions of the B, G and R signals in the original image on the subject distance. In the graph showing a relationship between the resolution and the subject distance illustrated in FIG. 9 (as well as FIG. 10 and the like), the horizontal axis and the vertical axis represent the subject distance and the resolution, respectively. The subject distance increases from the left to the right on the horizontal axis, and the resolution increases from the lower to the upper on the vertical axis.

The subject distances DD_{B}, DD_{G} and DD_{R} are subject distances when “XB=X_{IS}” holds corresponding to FIG. 7A, when “XG=X_{IS}” holds corresponding to FIG. 7B, and when “XR=X_{IS}” holds corresponding to FIG. 7C, respectively. Therefore, “DD_{B}<DD_{G}<DD_{R}” holds.

As the curve 320B indicates, a resolution of the B signal in the original image becomes largest when the subject distance is the distance DD_{B} and decreases along with decrease or increase of the subject distance from the distance DD_{B}. Similarly, as the curve 320G indicates, a resolution of the G signal in the original image becomes largest when the subject distance is the distance DD_{G} and decreases along with decrease or increase of the subject distance from the distance DD_{G}. Similarly, as the curve 320R indicates, a resolution of the R signal in the original image becomes largest when the subject distance is the distance DD_{R} and decreases along with decrease or increase of the subject distance from the distance DD_{R}.

As understood from the definition of the resolution described above, a resolution of the B signal in the original image indicates a maximum spacial frequency of the B signal in the original image (the same is true for the G signal and the R signal). If a resolution of a signal is relatively high, the signal contains relatively many high frequency components. Therefore, the B signal in an original signal contains high frequency components with respect to a subject at a relatively small subject distance (e.g., a subject at the distance DD_{B}). The R signal in the original signal contains high frequency components with respect to a subject at a relatively large subject distance (e.g., a subject at the distance DD_{R}). The G signal in the original signal contains high frequency components with respect to a subject at a medium subject distance (e.g., a subject at the distance DD_{G}). Note that a frequency component at a predetermined frequency or higher among frequency components contained in a signal is referred to as a high frequency component, and a frequency component lower than the predetermined frequency is referred to as a low frequency component.

By complementing these high frequency components with each other, it is possible to generate an image with a wide range of focus, i.e., an image with a large depth of field. FIG. 10 is a diagram in which a curve 320Y is added to FIG. 9. The curve 320Y indicates a resolution of the Y signal (i.e., a luminance signal) generated by complementing high frequency components of the B, G and R signals in the original signal. After such the complementing process, a subject (e.g., a background) at a subject distance different from that of a subject to be in focus (e.g., a human figure as a main subject) is made blur, so that an image with a narrow range of focus (i.e., an image with a small depth of field) can be obtained so that the subject to be in focus is in focus.

Concerning a noted image, a range of subject distance in which a resolution of the Y signal (or each of the B, G and R signals) becomes a predetermined reference resolution RS_{O} or higher is the depth of field as described above in the first embodiment, too. In the present embodiment, the depth of field may also be referred to as a range of focus.

FIG. 11 is a general block diagram of the image sensing apparatus 1 according to the present embodiment. The image sensing apparatus 1 includes individual portions denoted by numerals 10 to 24. The structure of the image sensing apparatus 1 can be applied to the image sensing apparatus 100 (see FIG. 1) according to the first embodiment. When the structure of the image sensing apparatus 1 of FIG. 11 is applied to the image sensing apparatus 100, it can be considered that the image taking portion 101 includes the optical system 10 and the image sensor 11, and that the original image generating portion 102 includes an AFE 12 and the demosaicing processing portion 14, and that the subject distance detection portion 103 includes a high frequency component extraction and distance detection portion 15, and that the target focused image generating portion 104 includes a depth of field expansion processing portion 16 and a depth of field control portion 17, and that the display controller 105 includes a display controller 25, and that the display portion 106 includes an LCD 19 and a touch panel controller 20.

The optical system 10 is constituted of a lens unit including a zoom lens for optical zooming and a focus lens for adjusting a focal position, and an iris stop for adjusting incident light quantity to the image sensor 11, so as to form an image having a desired angle of view and desired brightness on the imaging surface of the image sensor 11. The above-mentioned lens 10L corresponds to the optical system 10 that is regarded as a single lens. Therefore, the optical system 10 has axial chromatic aberration that is the same as the axial chromatic aberration of the lens 10L.

The image sensor 11 performs photoelectric conversion of an optical image (subject image) of light representing the subject that enters through the optical system 10, and an analog electric signal obtained by the photoelectric conversion is delivered to the AFE 12. The AFE (Analog Front End) 12 amplifies the analog signal from the image sensor 11 and converts the amplified analog signal into a digital signal so as to output the same. An amplification degree in the signal amplification by the AFE 12 is adjusted so that an output signal level of the AFE 12 is optimized, in synchronization with adjustment of an iris stop value in the optical system 10. Note that the output signal of the AFE 12 is also referred to as RAW data. The RAW data can be stored temporarily in a dynamic random access memory (DRAM) 13. In addition, the DRAM 13 can temporarily store not only the RAW data but also various data generated in the image sensing apparatus 1.

As described above, the image sensor 11 is a single plate image sensor having a Bayer arrangement. Therefore, in a two-dimensional image expressed by the RAW data, the red, green and blue color signals are arranged in a mosaic manner in accordance with the Bayer arrangement.

The demosaicing processing portion 14 performs a well-known demosaicing process on the RAW data so as to generate image data of an RGB format. The two-dimensional image expressed by the image data generated by the demosaicing processing portion 14 is referred to as an original image. Each pixel forming the original image is assigned with all the R, G and B signals. The R, G and B signals of a pixel are color signals that respectively indicate intensities of red, green and blue colors of the pixel. The R, G and B signals of the original image are represented by R0, G0 and B0, respectively.

The high frequency component extraction and distance detection portion 15 (hereinafter referred to as an extraction/detection portion 15 in short) extracts high frequency components of the color signals R0, G0 and B0 and estimates the subject distances of individual positions in the original image via the extraction, so as to generate subject distance information DIST indicating the estimated subject distance. In addition, information corresponding to a result of the extraction of the high frequency components is delivered to the depth of field expansion processing portion 16.

The depth of field expansion processing portion 16 (hereinafter referred to as an expansion processing portion 16 in short) expands the depth of field (i.e., increase the depth of field) of the original image expressed by the color signals R0, G0 and B0 based on information from the extraction/detection portion 15, so as to generate an intermediate image. The R, G and B signals of the intermediate image are denoted by R1, G1 and B1, respectively.

The depth of field control portion 17 adjusts the depth of field of the intermediate image based on the subject distance information DIST and the depth of field set information specifying the depth of field of the target focused image, so as to generate the target focused image with a small depth of field. The depth of field set information defines a value of the depth of field with respect to the target focused image and defines which subject should be the focused subject. The depth of field set information is generated by a CPU 23 based on a user's instruction or the like. The R, G and B signals of the target focused image are denoted by R2, G2 and B2, respectively.

The R, G and B signals of the target focused image are supplied to a camera signal processing portion 18. It is possible to supply the R, G and B signals of the original image or the intermediate image to the camera signal processing portion 18.

The camera signal processing portion 18 converts the R, G and B signals of the original image, the intermediate image or the target focused image into a image signal of the YUV format including the luminance signal Y and color difference signals U and V, which are output. The image signal is supplied to the liquid crystal display (LCD) 19 or an external display device (not shown) disposed outside of the image sensing apparatus 1, so that the original image, the intermediate image or the target focused image can be displayed on a display screen of the LCD 19 or on a display screen of the external display device.

In the image sensing apparatus 1, so-called touch panel operation is available. The user can touch the display screen of the LCD 19 so as to operate the image sensing apparatus 1 (i.e., to perform the touch panel operation). The touch panel controller 20 receives the touch panel operation by detecting a pressure applied onto the display screen of the LCD 19 or by other detection.

A compression/expansion processing portion 21 compresses the image signal output from the camera signal processing portion 18 by using a predetermined compression method so as to generate a compressed image signal. In addition, it is also possible to expand the compressed image signal so as to restore the image signal before the compression. The compressed image signal can be recorded in a recording medium 22 that is a nonvolatile memory such as a secure digital (SD) memory card. In addition, it is possible to record the RAW data in the recording medium 22. The central processing unit (CPU) 23 integrally controls operations of individual portions of the image sensing apparatus 1. The operation portion 24 receives various operations for the image sensing apparatus 1. Contents of the operation to the operation portion 24 are sent to the CPU 23.

The display controller 25 included in the camera signal processing portion 18 has the function similar to the display controller 105 (see FIG. 1) described above in the first embodiment. In other words, the modifying process described above in the first embodiment is performed on the target focused image based on the subject distance information DIST and the depth of field set information, so that the emphasis display image to be displayed on the display screen of the LCD 19 is generated. The modifying process is performed so that the in-focus region in the obtained emphasis display image can be visually distinguished on the display screen of the LCD 19.

The operational procedure of the first embodiment illustrated in FIG. 5 can also be applied to the second embodiment. In other words, if the user performs the adjustment operation on the target focused image that is once generated and the emphasis display image based on the target focused image, the depth of field set information is changed in accordance with the specified depth of field changed by the adjustment operation, and image data of the target focused image is generated again from image data of the intermediate image (or the original image) in accordance with the changed depth of field set information, so as to generate and display the emphasis display image based on the new target focused image. After that, user's confirmation operation or adjustment operation is received again. If the confirmation operation is performed by the user, the image data of the target focused image, from which the currently displayed emphasis display image is generated, is compressed and is recorded in the recording medium 22.

[Principle of Generating the Target Focused Image: Principle of Controlling the Depth of Field]

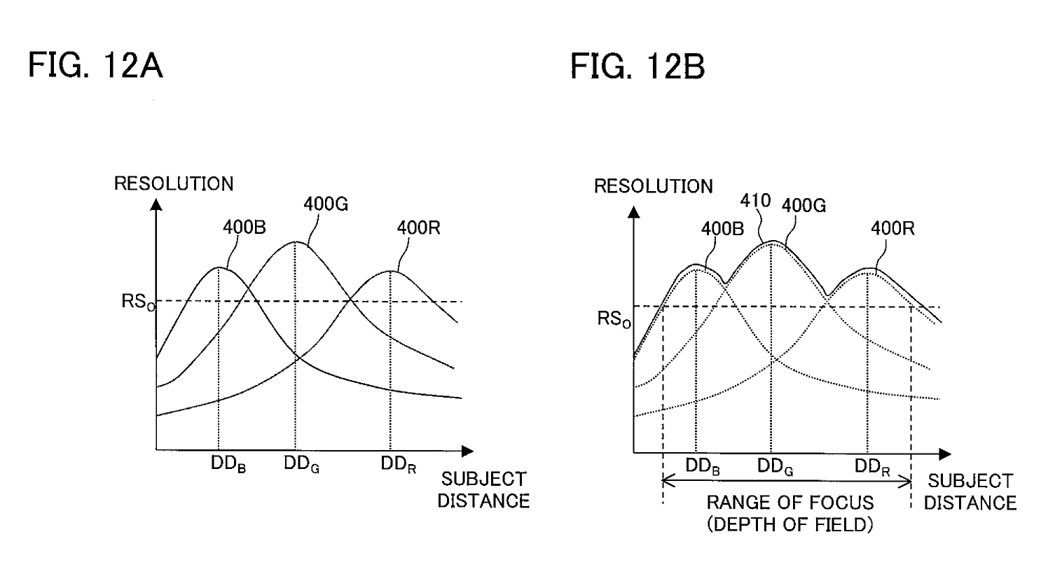

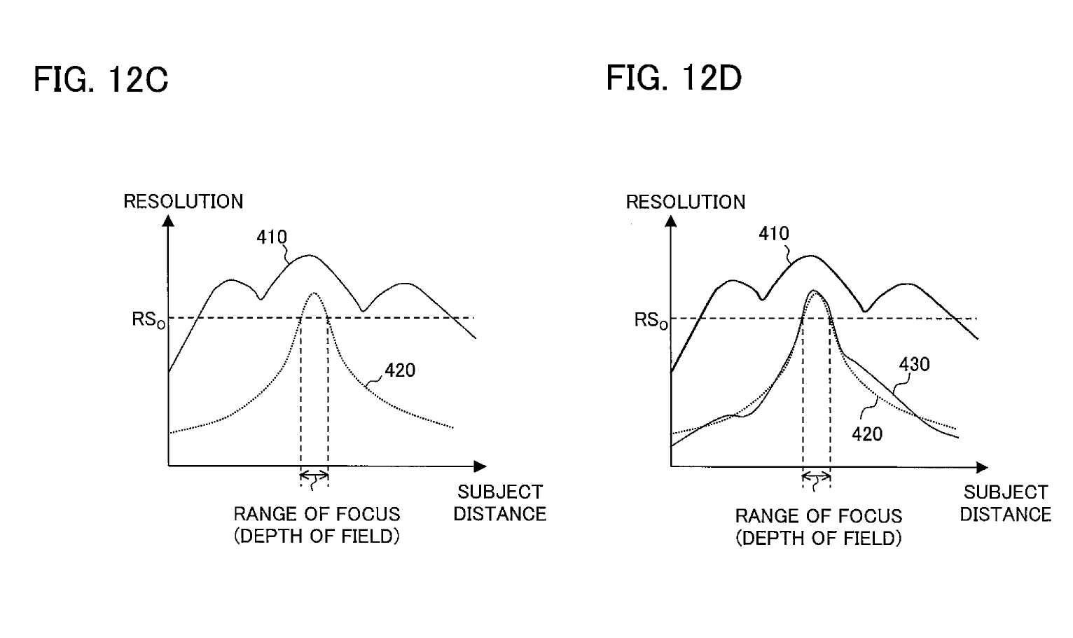

With reference to FIGS. 12A to 12D, the principle of the method for generating the target focused image from the original image will be described. In FIG. 12A, curves 400B, 400G and 400R respectively indicate dependencies of resolutions of the B, G and R signals in the original image on the subject distance, in other words, dependencies of resolutions of the color signals B0, G0 and R0 on the subject distance. The curves 400B, 400G and 400R are the same as the curves 320B, 320G and 320R in FIG. 9, respectively. The distances DD_{B}, DD_{G} and DD_{R} in FIGS. 12A and 12B are the same as those illustrated in FIG. 9.

The subject distance at which the resolution increases is different among the color signals B0, G0 and R0 because of axial chromatic aberration. As described above, the color signal B0 contains high frequency components with respect to a subject at a relatively small subject distance, the color signal R0 contains high frequency components with respect to a subject at a relatively large subject distance, and the color signal G0 contains high frequency components with respect to a subject at a medium subject distance.

After obtaining such the color signals B0, G0 and R0, a signal having a largest high frequency component is specified among the color signals B0, G0 and R0, and high frequency components of the specified color signal are added to two other color signals so that the color signals B1, G1 and R1 of the intermediate image can be generated. Amplitude of a high frequency component of each color signal changes along with a change of the subject distance. Therefore, this generation process is performed separately for each of a first subject distance, a second subject distance, a third subject distance, and so on, which are different each other. Subjects having various subject distances appear in the entire image region of the original image, and the subject distance of each subject is estimated by the extraction/detection portion 15 illustrated in FIG. 11.

In FIG. 12B, a curve 410 indicates dependencies of the resolutions of the B, G and R signals in the intermediate image on the subject distance, in other words, dependencies of resolutions of the color signals B1, G1 and R1 on the subject distance. The curve 410 is like a curve obtained by connecting a maximum value of the resolutions of the color signals B0, G0 and R0 at the first subject distance, a maximum value of the resolutions of the color signals B0, G0 and R0 at the second subject distance, a maximum value of the resolutions of the color signals B0, G0 and R0 at the third subject distance, and so on. The range of focus (depth of field) of the intermediate image is larger than that of the original image, and the range of focus (depth of field) of the intermediate image contains the distances DD_{B}, DD_{G} and DD_{R}.

While the intermediate image is generated, the depth of field curve 420 illustrated in FIG. 12C is set based on user's instruction or the like. The depth of field control portion 17 illustrated in FIG. 11 corrects the B, G and R signals of the intermediate image so that the curve indicating the subject distance dependency of the resolution of the B, G and R signals in the target focused image becomes generally the same as the depth of field curve 420. A solid line curve 430 in FIG. 12D indicates the subject distance dependency of the resolution of the B, G and R signals in the target focused image obtained by this correction, in other words, the subject distance dependency of the resolution of the color signals B2, G2 and R2. If the depth of field curve 420 is set appropriately, a target focused image with a narrow range of focus (target focused image with a small depth of field) can be generated. In other words, it is possible to generate a target focused image in which only a subject at a desired subject distance is in focus while subjects at other subject distances are blurred.

The principle of the method for generating the color signals B1, G1 and R1 from the color signals B0, G0 and R0 will further be described in a supplementary manner. The color signals B0, G0, R0, B1, G1 and R1 are regarded as functions of the subject distance D, which are expressed by B0(D), G0(D), R0(D), B1(D), G1(D) and R1(D) respectively. The color signal G0(D) can be separated into a high frequency component Gh(D) and a low frequency component GL(D). Similarly, the color signal B0(D) can be separated into a high frequency component Bh(D) and a low frequency component BL(D). The color signal R0(D) can be separated into a high frequency component Rh(D) and a low frequency component RL(D). In other words, the following equations hold.

G0(D)=Gh(D)+GL(D)

B0(D)=Bh(D)+BL(D)

R0(D)=Rh(D)+RL(D)

Supposing that the optical system 10 has no axial chromatic aberration, the following equation (1) as well as the following equation (2) usually holds because of property of the image in which color changes little locally. This is true for any subject distance. A subject in a real space has various color components. However, if the color component of a subject is viewed locally, color usually changes little though luminance changes in a micro region. For instance, when color components of green leaves are scanned in a certain direction, patterns of the leaves cause a variation of luminance but little variation of color (hue or the like). Therefore, supposing that the optical system 10 has no axial chromatic aberration, the equations (1) and (2) hold in many cases.

Gh(D)/Bh(D)=GL(D)/BL(D) (1)

Gh(D)/GL(D)=Bh(D)/BL(D)=Rh(D)/RL(D) (2)

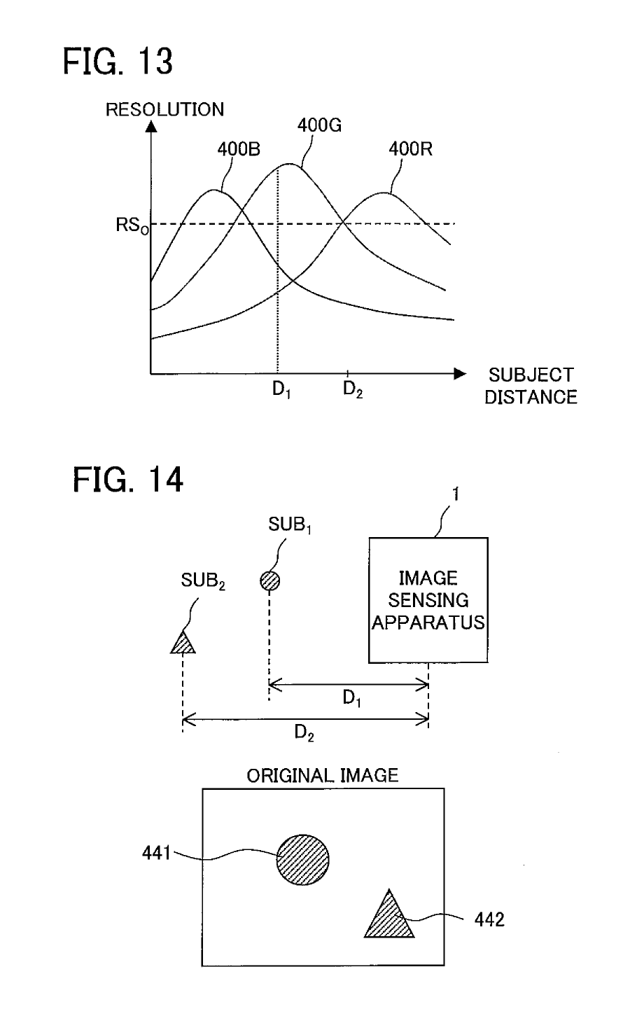

On the other hand, the optical system 10 actually has axial chromatic aberration. Therefore, the color signals B0(D), G0(D) and R0(D) have different high frequency components with respect to any subject distance. Conversely, using one color signal having a many high frequency component with respect to a certain subject distance, it is possible to compensate high frequency components of two other color signals. For instance, it is supposed that the resolution of the color signal G0(D) is larger than those of the color signals B0(D) and R0(D) at a subject distance D₁, and that a subject distance D₂ is larger than the subject distance D₁, as illustrated in FIG. 13. In addition, as illustrated in FIG. 14, an image region as a part of the original image, in which image data of a subject SUB₁ with the subject distance D₁ exists, is denoted by numeral 441. In addition, an image region as a part of the original image, in which image data of a subject SUB₂ with the subject distance D₂ exists, is denoted by numeral 442. Images of the subjects SUB₁ and SUB₂ appear in the image regions 441 and 442, respectively.

The G signal in the image region 441, i.e., G0(D₁)(=Gh(D₁)+GL(D₁)) contains many high frequency components, but the B signal and the R signal in the image region 441, i.e., B0(D₁)(=Bh(D₁)+BL(D₁)) and R0(D₁)(=Rh(D₁)+RL(D₁)) do not contain many high frequency component due to axial chromatic aberration. The high frequency components of the B signal and the R signal in the image region 441 are generated by using the high frequency component of the G signal in the image region 441. If the generated high frequency components of the B signal and the R signal in the image region 441 are represented by Bh′(D₁) and Rh′(D₁) respectively, Bh′(D₁) and Rh′(D₁) are determined by the following equations (3) and (4).

Bh′(D₁)=BL(D₁)×Gh(D₁)/GL(D₁) (3)

Rh′(D₁)=RL(D₁)×Gh(D₁)/GL(D₁) (4)

If the optical system 10 has no axial chromatic aberration, it can be considered that “Bh(D₁)=BL(D₁)×Gh(D₁)/GL(D₁)” and “Rh(D₁)=RL(D₁)×Gh(D₁)/GL(D₁)” hold from the above-mentioned equations (1) and (2). However, because of the existing axial chromatic aberration of the optical system 10, the high frequency components Bh(D₁) and Rh(D₁) are missing from the B signal and the R signal of the original image with respect to the subject distance D₁. The missing part is generated based on the above equations (3) and (4).

Note that the high frequency component Bh(D₁) of B0(D₁) and the high frequency component Rh(D₁) of R0(D₁) are actually little. Therefore, it can be regarded that B0(D₁) is nearly equal to BL(D₁) and R0(D₁) is nearly equal to RL(D₁). Thus, with respect to the subject distance D₁, B1(D₁) and R1(D₁) are determined by using B0(D₁), R0(D₁) and Gh(D₁)/GL(D₁) in accordance with the equations (5) and (6), so that the signals B1 and R1 including the high frequency components are generated. G1(D₁) is regarded as G0(D₁) itself as shown in equation (7).

$$\begin{matrix}\begin{matrix}B 1 ( {D}_{1} ) = BL ( {D}_{1} ) + {Bh}^{′} ( {D}_{1} ) \\ \approx B 0 ( {D}_{1} ) + B 0 ( {D}_{1} ) \times Gh ( {D}_{1} ) / GL ( {D}_{1} )\end{matrix} & ( 5 ) \\ \begin{matrix}R 1 ( {D}_{1} ) = RL ( {D}_{1} ) + {Rh}^{′} ( {D}_{1} ) \\ \approx R 0 ( {D}_{1} ) + R 0 ( {D}_{1} ) \times Gh ( {D}_{1} ) / GL ( {D}_{1} )\end{matrix} & ( 6 ) \\ G 1 ( {D}_{1} ) = G 0 ( {D}_{1} ) & ( 7 )\end{matrix}$$

The above description of the method for generating the signals B1, G1 and R1 pays attention to the image region 441 in which the G signal contains many high frequency components. Similar generation process is performed also with respect to the image region in which the B signal or the R signal contains many high frequency components.

[High Frequency Component Extraction, Distance Estimation and Expansion of the Depth of Field]

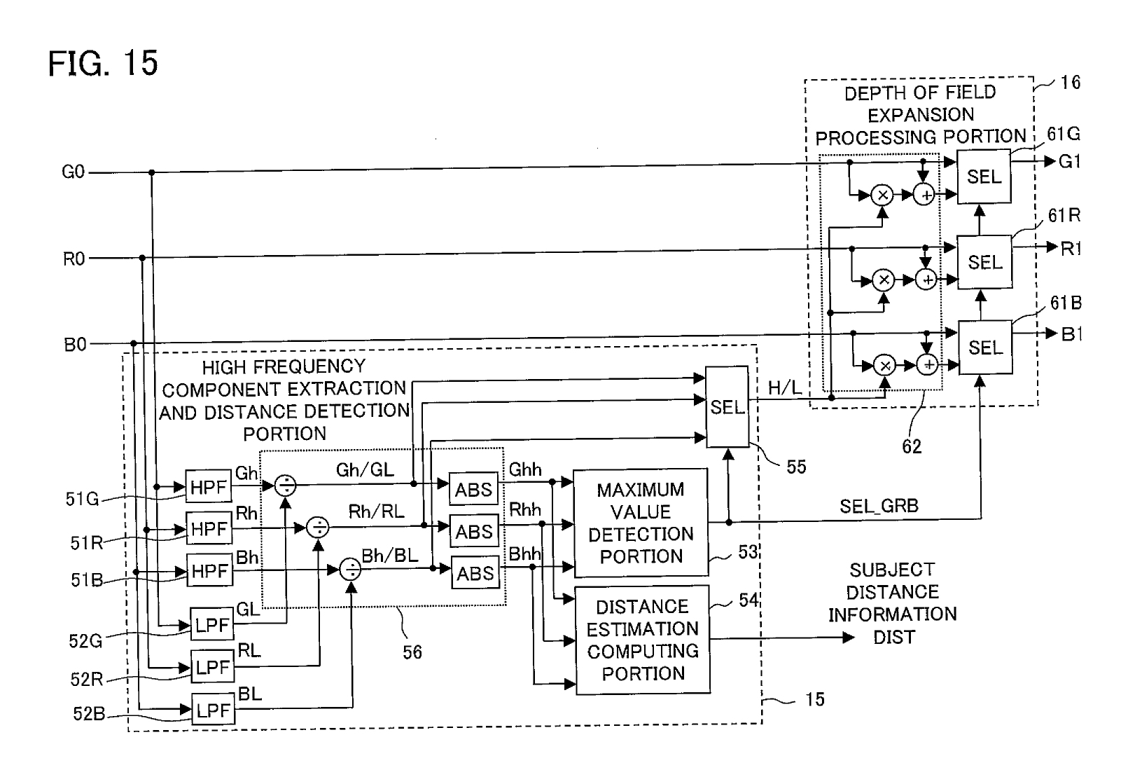

An example of a detailed structure of a portion that performs the process based on the above-mentioned principle will be described. FIG. 15 is an internal block diagram of the extraction/detection portion 15 and the expansion processing portion 16 illustrated in FIG. 11. The color signals G0, R0 and B0 of the original image are supplied to the extraction/detection portion 15 and the expansion processing portion 16. The extraction/detection portion 15 includes a high pass filters (HPF) 51G 51R and 51B, low pass filters (LPF) 52G, 52R and 52B, a maximum value detection portion 53, a distance estimation computing portion 54, a selecting portion 55 and a computing portion 56. The expansion processing portion 16 includes selecting portions 61G, 61R and 61B, and a computing portion 62.

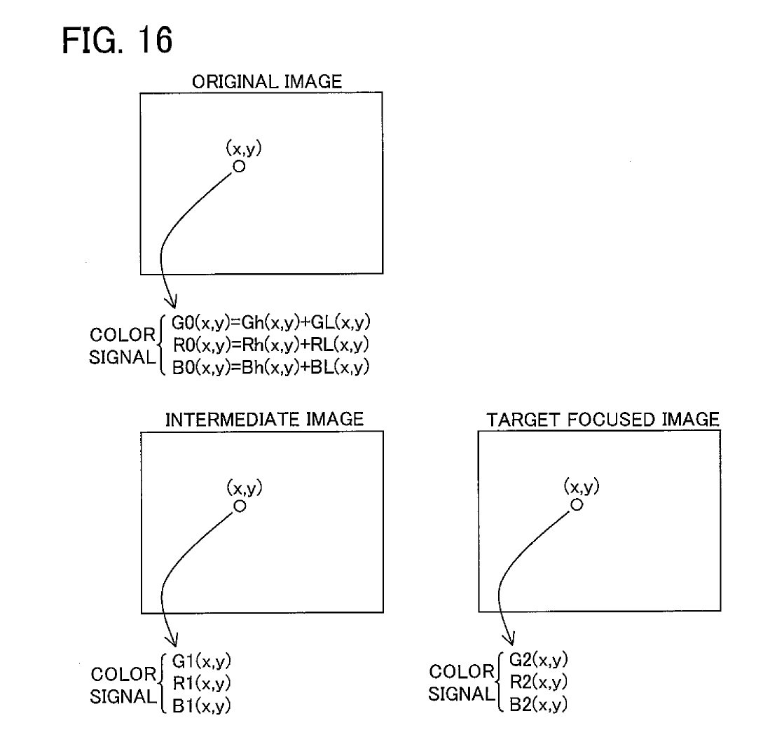

Any two-dimensional image such as the original image, the intermediate image or the target focused image is constituted of a plurality of pixels arranged in the horizontal and vertical directions like a matrix. As illustrated in FIG. 16, a position of a noted pixel in the two-dimensional image is represented by (x, y). The letters x and y represent coordinate values of the noted pixel in the horizontal direction and in the vertical direction, respectively. Then, the color signals G0, R0 and B0 at the pixel position (x, y) in the original image are represented by G0(x, y), R0(x, y) and B0(x, y), respectively. The color signals G1, R1 and B1 at the pixel position (x, y) in the intermediate image are represented by G1(x, y), R1(x, y) and B1(x, y), respectively. The color signals G2, R2 and B2 at the pixel position (x, y) in the target focused image are represented by G2(x, y), R2(x, y) and B2(x, y), respectively.

The HPFs 51G, 51R and 51G are two-dimensional spatial filters having the same structure and the same characteristics. The HPFs 51G, 51R and 51G extract predetermined high frequency components Gh, Rh and Bh contained in the signals G0, R0 and B0 by filtering the input signals G0, R0 and B0. The high frequency components Gh, Rh and Bh extracted with respect to the pixel position (x, y) are represented by Gh(x, y), Rh(x, y) and Bh(x, y), respectively.

The spatial filter outputs the signal obtained by filtering the input signal supplied to the spatial filter. The filtering with the spatial filter means the operation for obtaining the output signal of the spatial filter by using the input signal at the noted pixel position (x, y) and the input signals at positions around the noted pixel position (x, y). The input signal value at the noted pixel position (x, y) is represented by I_{IN}(x, y), and the output signal of the spatial filter with respect to the noted pixel position (x, y) is represented by I_{O}(x, y). Then, I_{IN}(x, y) and I_{O}(x, y) satisfy the relationship of the equation (8) below. Here, h(u, v) represents a filter factor of the spatial filter at the position (u, v). A filter size of the spatial filter in accordance with the equation (8) is (2w+1)×(2w+1). Letter w denotes a natural number.

$${I}_{O} ( x , y ) = {\sum }_{v = - w}^{w} {\sum }_{u = - w}^{w} \{ h ( u , v ) \cdot {I}_{IN} ( x + u , y + v ) \} \qquad ( 8 )$$

The HPF 51G is a spatial filter such as a Laplacian filter that extracts and outputs a high frequency component of the input signal. The HPF 51G uses the input signal G0(x, y) at the noted pixel position (x, y) and the input signals (G0(x+1, y+1) and the like) at positions around the noted pixel position (x, y) so as to obtain the output signal Gh(x, y) with respect to the noted pixel position (x, y). The same is true for the HPFs 51R and 51B.

The LPFs 52G, 52R and 52B are two-dimensional spatial filters having the same structure and the same characteristics. The LPFs 52G, 52R and 52B extract predetermined low frequency components GL, RL and BL contained in the signals G0, R0 and B0 by filtering the input signals G0, R0 and B0. The low frequency components GL, RL and BL extracted with respect to the pixel position (x, y) are represented by GL(x, y), RL(x, y) and BL(x, y), respectively. It is possible to determine the low frequency components GL(x, y), RL(x, y) and BL(x, y) in accordance with “GL(x, y)=G0(x, y)−Gh(x, y), RL(x, y)=R0(x, y)−Rh(x, y) and BL(x, y)=B0(x, y)−Bh(x, y)”.

The computing portion 56 normalizes the high frequency component obtained as described above with the low frequency component for each color signal and for each pixel position, so as to determine the values Gh(x, y)/GL(x, y), Rh(x, y)/RL(x, y) and Bh(x, y)/BL(x, y). Further, the computing portion 56 determines the absolute values Ghh(x, y)=|Gh(x, y)/GL(x, y)|, Rhh(x, y)=|Rh(x, y)/RL(x, y)| and Bhh(x, y)=|Bh(x, y)/BL(x, y)| for each color signal and for each pixel position.

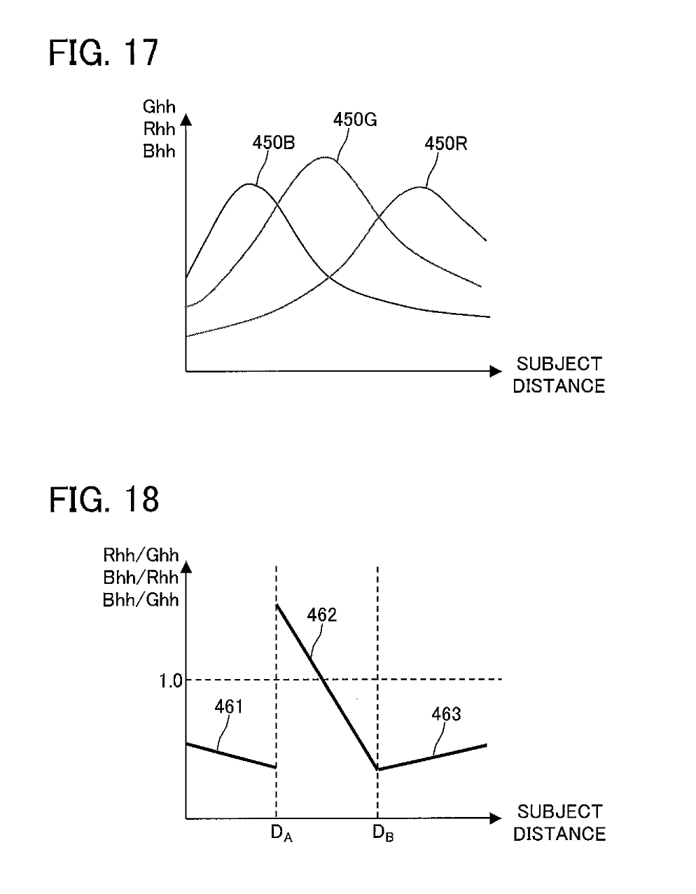

A relationship among the subject distance and the signals Ghh, Rhh and Bhh obtained by the computing portion 56 is illustrated in FIG. 17. The absolute values Ghh(x, y), Rhh(x, y) and Bhh(x, y) are values of the signals Ghh, Rhh and Bhh at the position (x, y), respectively. The curves 450G, 450R and 450B are obtained by plotting changes of the signals Ghh, Rhh and Bhh along with the change of the subject distance, respectively. As understood from the comparison between the curve 400G in FIG. 12A and the curve 450G in FIG. 17, the subject distance dependency of the signal Ghh is the same as or similar to the subject distance dependency of the resolution of the signal G0 (the same is true for the signals Rhh and Bhh). It is because that when the resolution of the signal G0 increases or decreases, the high frequency component Gh of the signal G0 and the signal Ghh that is proportional to the absolute value thereof also increase or decrease.

The maximum value detection portion 53 specifies a maximum value among the absolute values Ghh(x, y), Rhh(x, y) and Bhh(x, y) for each pixel position, and outputs a signal SEL_GRB(x, y) that indicates which one of the absolute values Ghh(x, y), Rhh(x, y) and Bhh(x, y) is the maximum value. The case where Bhh(x, y) is the maximum value among the absolute values Ghh(x, y), Rhh(x, y) and Bhh(x, y) is referred to as Case 1, the case where Ghh(x, y) is the maximum value is referred to as Case 2, and the case where Rhh(x, y) is the maximum value is referred to as Case 3.

The distance estimation computing portion 54 estimates a subject distance DIST(x, y) of the subject at the pixel position (x, y) based on the absolute values Ghh(x, y), Rhh(x, y) and Bhh(x, y). This estimation method will be described with reference to FIG. 18. First, in the distance estimation computing portion 54, the two subject distances D_{A} and D_{B} that satisfy “0<D_{A}<D_{B}” are defined in advance. The distance estimation computing portion 54 changes the estimation method of the subject distance in accordance with which one of the absolute values Ghh(x, y), Rhh(x, y) and Bhh(x, y) is the maximum value.

In Case 1, it is decided that a subject distance of the subject at the pixel position (x, y) is relatively small, and the estimated subject distance DIST(x, y) is determined from the Rhh(x, y)/Ghh(x, y) within the range that satisfies “0<DIST(x, y)<D_{A}”. A line segment 461 in FIG. 18 indicates a relationship between the Rhh(x, y)/Ghh(x, y) and the estimated subject distance DIST(x, y) in Case 1. In Case 1 where Bhh(x, y) becomes the maximum value, as illustrated in FIG. 17, both Ghh(x, y) and Rhh(x, y) increase along with increase of the subject distance corresponding to the pixel (x, y). It is considered that a degree of increase of Ghh(x, y) with respect to increase of the subject distance is larger than that of Rhh(x, y). Therefore, in Case 1, the estimated subject distance DIST(x, y) is determined so that the DIST(x, y) increases along with decrease of Rhh(x, y)/Ghh(x, y).

In Case 2, it is decided that the subject distance of the subject at the pixel position (x, y) is medium, the estimated subject distance DIST(x, y) is determined from the Bhh(x, y)/Rhh(x, y) within the range that satisfies “D_{A}≦DIST(x, y)<D_{B}”. A line segment 462 in FIG. 18 indicates a relationship between the Bhh(x, y)/Rhh(x, y) and the estimated subject distance DIST(x, y) in Case 2. In Case 2 where Ghh(x, y) becomes the maximum value, as illustrated in FIG. 17, Bhh(x, y) decreases while Rhh(x, y) increases along with increase of the subject distance corresponding to the pixel (x, y). Therefore, in Case 2, the estimated subject distance DIST(x, y) is determined so that the DIST(x, y) increases along with decrease of Rhh(x, y)/Ghh(x, y).

In Case 3, it is decided that the subject distance of the subject at the pixel position (x, y) is relatively large, and the estimated subject distance DIST(x, y) is determined from the Bhh(x, y)/Ghh(x, y) within the range that satisfies “D_{B}<DIST(x, y)”. A line segment 463 in FIG. 18 indicates a relationship between the Bhh(x, y)/Ghh(x, y) and the estimated subject distance DIST(x, y) in Case 3. In Case 3 where Rhh(x, y) becomes the maximum value, as illustrated in FIG. 17, both Ghh(x, y) and Bhh(x, y) decrease along with increase of the subject distance corresponding to the pixel (x, y). It is considered that a degree of decrease of Ghh(x, y) with respect to increase of the subject distance is larger than that of Bhh(x, y). Therefore, in Case 3, the estimated subject distance DIST(x, y) is determined so that the DIST(x, y) increases along with increase of Bhh(x, y)/Ghh(x, y).

The subject distance dependencies of the resolutions of the color signals indicated by the curves 320G, 320R and 320B in FIG. 9 and the subject distance dependencies of the signals Ghh, Rhh and Bhh corresponding to them (see FIG. 17) are determined by the axial chromatic aberration characteristics of the optical system 10, and the axial chromatic aberration characteristics are determined in the designing stage of the image sensing apparatus 1. In addition, the line segments 461 to 463 in FIG. 18 can be determined from the shapes of the curves 450G; 450R and 450B indicating subject distance dependencies of the signals Ghh, Rhh and Bhh. Therefore, the relationship among the Ghh(x, y), Rhh(x, y), Bhh(x, y) and DIST(x, y) can be determined in advance from the axial chromatic aberration characteristics of the optical system 10. Actually, for example, a lookup table (LUT) storing the relationship is provided to the distance estimation computing portion 54, so that the DIST(x, y) can be obtained by giving Ghh(x, y), Rhh(x, y) and Bhh(x, y) to the LUT. Information containing the estimated subject distance DIST(x, y) of every pixel position is referred to as the subject distance information DIST.

In this way, image data of the original image contains information depending on a subject distance of the subject because the axial chromatic aberration exists. The extraction/detection portion 15 extracts the information as signals Ghh, Rhh and Bhh, and determines the DIST(x, y) by using a result of the extraction and known axial chromatic aberration characteristics.

The selecting portion 55 selects one of the values Gh(x, y)/GL(x, y), Rh(x, y)/RL(x, y) and Bh(x, y)/BL(x, y) computed by the computing portion 56 based on the signal SEL_GRB(x, y), and outputs the selected value as H(x, y)/L(x, y). Specifically, in Case 1 where Bhh(x, y) becomes the maximum value, Bh(x, y)/BL(x, y) is output as H(x, y)/L(x, y); in Case 2 where Ghh(x, y) becomes the maximum value, Gh(x, y)/GL(x, y) is output as H(x, y)/L(x, y); and in Case 3 where Rhh(x, y) becomes the maximum value, Rh(x, y)/RL(x, y) is output as H(x, y)/L(x, y).

The expansion processing portion 16 is supplied with the color signals G0(x, y), R0(x, y) and B0(x, y) of the original image, and the signal H(x, y)/L(x, y). The selecting portions 61G, 61R and 61B select one of the first and the second input signals based on the signal SEL_GRB(x, y), and output the selected signals as G1(x, y), R1(x, y) and B1(x, y), respectively. The first input signals of the selecting portions 61G, 61R and 61B are G0(x, y), R0(x, y) and B0(x, y), respectively. The second input signals of the selecting portions 61G, 61R and 61B are “G0(x, y)+G0(x, y)×H(x, y)/L(x, y)”, “R0(x, y)+R0(x, y)×H(x, y)/L(x, y)” and “B0(x, y)+B0(x, y)×H(x, y)/L(x, y)”, respectively, which are determined by the computing portion 62.

In Case 1 where Bhh(x, y) becomes the maximum value, selecting processes in the selecting portions 61G, 61R and 61B are performed so as to satisfy the following equations:

G1(x,y)=G0(x,y)+G0(x,y)×H(x,y)/L(x,y),

R1(x,y)=R0(x,y)+R0(x,y)×H(x,y)/L(x,y), and

B1(x,y)=B0(x,y).

In Case 2 where Ghh(x, y) becomes the maximum value, selecting processes in the selecting portions 61G, 61R and 61B are performed so as to satisfy the following equations:

G1(x,y)=G0(x,y),

R1(x,y)=R0(x,y)+R0(x,y)×H(x,y)/L(x,y), and

B1(x,y)=B0(x,y)+B0(x,y)×H(x,y)/L(x,y).

In Case 3 where Rhh(x, y) becomes the maximum value, selecting processes in the selecting portions 61G, 61R and 61B are performed so as to satisfy the following equations:

G1(x,y)=G0(x,y)+G0(x,y)×H(x,y)/L(x,y),

R1(x,y)=R0(x,y), and

B1(x,y)=B0(x,y)+B0(x,y)×H(x,y)/L(x,y).

For instance, if the noted pixel position (x, y) is a pixel position within the image region 441 in FIG. 14 (also see FIG. 13), the absolute value Ghh(x, y) becomes the maximum value among Ghh(x, y), Rhh(x, y) and Bhh(x, y). Therefore, in this case, “H(x, y)/L(x, y)=Gh(x, y)/GL(x, y)” holds. Thus, with respect to the pixel position (x, y) corresponding to the subject distance D₁, the following equations are satisfied:

G1(x,y)=G0(x,y),

R1(x,y)=R0(x,y)+R0(x,y)×Gh(x,y)/GL(x,y), and

B1(x,y)=B0(x,y)+B0(x,y)×Gh(x,y)/GL(x,y).

These three equations correspond to the above equations (5) to (7) in which “(D₁)” is replaced with “(x, y)”.

[Concrete Method of Generating the Target Focused Image]

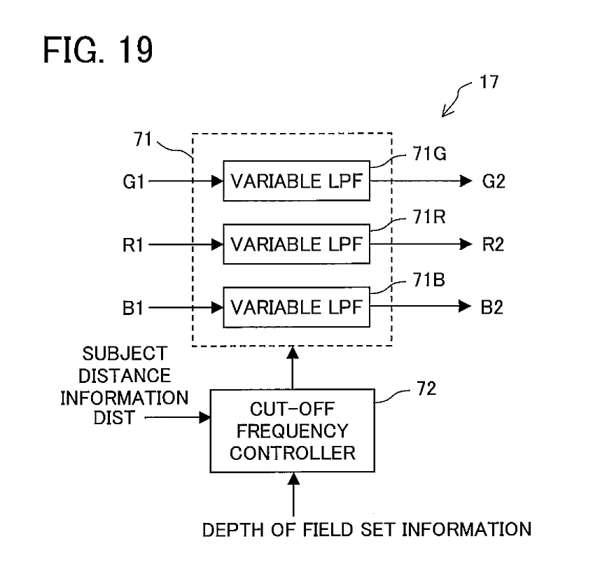

FIG. 19 is an internal block diagram of the depth of field control portion 17 illustrated in FIG. 11. The depth of field control portion 17 illustrated in FIG. 19 is equipped with a variable LPF portion 71 and a cut-off frequency controller 72. The variable LPF portion 71 includes three variable LPFs (low pass filters) 71G, 71R and 71B that can set cut-off frequencies in variable manner. The cut-off frequency controller 72 controls cut-off frequencies of the variable LPFs 71G, 71R and 71B based on the subject distance information DIST and the depth of field set information. When the signals G1, R1 and B1 are supplied to the variable LPFs 71G, 71R and 71B, the color signals G2, R2 and B2 that represent the target focused image are obtained from the variable LPFs 71G, 71R and 71B.

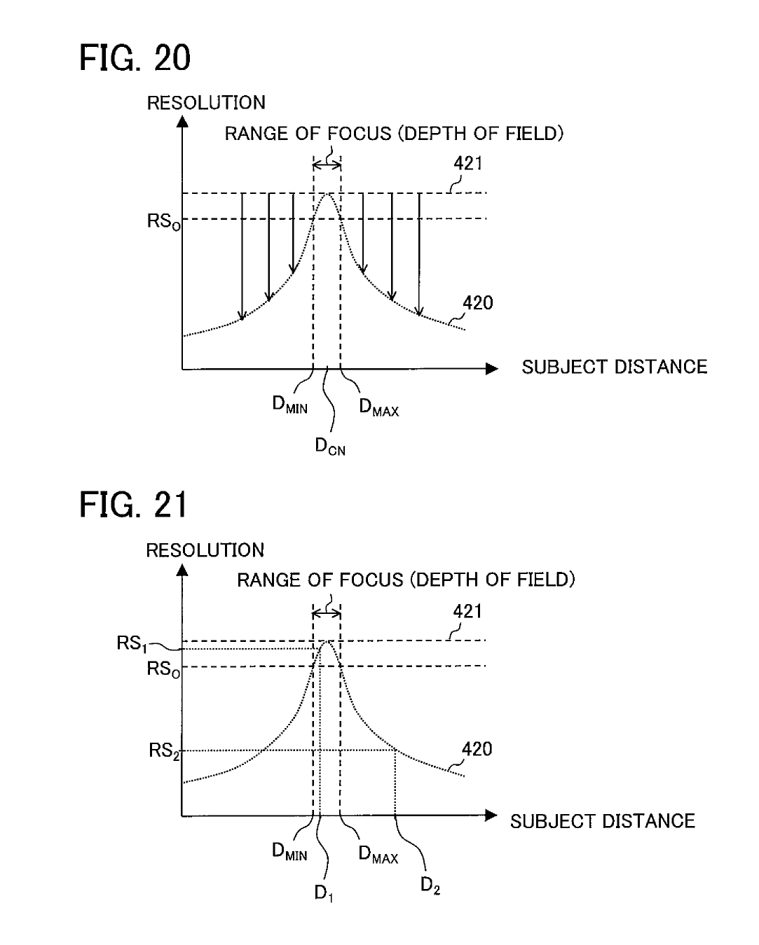

The depth of field set information is generated based on a user's instruction or the like prior to generation of the color signals G2, R2 and B2. The depth of field curve 420 illustrated in FIG. 20 that is the same as that illustrated in FIG. 12C is set from the depth of field set information. In the specified depth of field indicated by the depth of field set information, the shortest subject distance is denoted by D_{MIN}, and the longest subject distance is denoted by D_{MAX} (see FIG. 20). Naturally, “0<D_{MIN}<D_{MAX}” holds.

The depth of field set information is used for determining which subject should be the focused subject and determining the subject distances D_{MIN}, D_{CN} and D_{MAX} to be within the depth of field of the target focused image. The subject distance D_{CN} is the center distance in the depth of field of the target focused image, and “D_{CN}=(D_{MIN}+D_{MAX})/2” holds. The user can directly set a value of D_{CN}. In addition, the user can also specifies directly a distance difference (D_{MAX}−D_{MIN}) indicating a value of the specified depth of field. However, a fixed value that is set in advance may be used as the distance difference (D_{MAX}−D_{MIN}).

In addition, the user can also determine a value of D_{CN} by designating a specific subject to be the focused subject. For instance, the original image or the intermediate image or the target focused image that is temporarily generated is displayed on the display screen of the LCD 19, and in this state the user designates a display part in which the specific subject is displayed by using the touch panel function. The D_{CN} can be set from a result of the designation and the subject distance information DIST. More specifically, for example, if the specific subject for the user is the subject SUB₁ in FIG. 14, the user utilizes the touch panel function for performing the operation of designating the image region 441. Then, the subject distance DIST(x, y) estimated with respect to the image region 441 is set as the D_{CN} (if the estimation is performed ideally, “D_{CN}=D₁” holds).

The depth of field curve 420 is a curve that defines a relationship between the subject distance and the resolution. The resolution on the depth of field curve 420 has the maximum value at the subject distance D_{CN} and decreases gradually as the subject distance becomes apart from the D_{CN} (see FIG. 20). The resolution on the depth of field curve 420 at the subject distance D_{CN} is larger than the reference resolution RS_{O}, and the resolutions on the depth of field curve 420 at the subject distances D_{MIN} and D_{MAX} are the same as the reference resolution RS_{O}.

In the cut-off frequency controller 72, a virtual signal is assumed, in which the resolution corresponds to a largest resolution on the depth of field curve 420 at every subject distance. A broken line 421 in FIG. 20 indicates subject distance dependency of the resolution in the virtual signal. The cut-off frequency controller 72 determines a cut-off frequency of the low pass filter that is necessary for converting the broken line 421 into the depth of field curve 420 by a low-pass filtering process. In other words, an output signal of the variable LPFs 71G, 71R and 71B when the virtual signal is supposed to be an input signal to the variable LPFs 71G, 71R and 71B is referred to as a virtual output signal. Then, the cut-off frequency controller 72 sets the cut-off frequencies of the variable LPFs 71G, 71R and 71B so that the curve that indicates the subject distance dependency of the resolution of the virtual output signal corresponds to the depth of field curve 420. In FIG. 20, vertical solid line arrows indicate a manner in which the resolution of the virtual signal corresponding to the broken line 421 is lowered to the resolution of the depth of field curve 420.

The cut-off frequency controller 72 determines which cut-off frequency should be set to which image region based on the subject distance information DIST. For instance (see FIG. 14), suppose the case in where a pixel position (x₁, y₁) exists in the image region 441 in which image data of the subject SUB₁ at the subject distance D₁ exists, and a pixel position (x₂, y₂) exists in the image region 442 in which image data of the subject SUB₂ at the subject distance D₂ exists. In this case, ignoring estimation error of the subject distance, an estimated subject distance DIST(x₁, y₁) of the pixel position (x₁, y₁) and estimated subject distances of the pixel positions around the same become D₁, while an estimated subject distance DIST(x₂, y₂) of the pixel position (x₂, y₂) and estimated subject distances of the pixel positions around the same become D₂. In addition, as illustrated in FIG. 21, it is supposed that resolutions on the depth of field curve 420 at the subject distances D₁ and D₂ are RS₁ and RS₂, respectively.

In this case, the cut-off frequency controller 72 determines a cut-off frequency CUT₁ of the low pass filter that is necessary for lowering the resolution of the virtual signal corresponding to the broken line 421 to the resolution RS₁, and applies the cut-off frequency CUT₁ to the signals G1, R1 and B1 within the image region 441. Thus, the variable LPFs 71G, 71R and 71B perform the low-pass filtering process with the cut-off frequency CUT₁ on the signals G1, R1 and B1 within the image region 441. The signals after this low-pass filtering process are output as signals G2, R2 and B2 within the image region 441 in the target focused image.

Similarly, the cut-off frequency controller 72 determines a cut-off frequency CUT₂ of the low pass filter that is necessary for lowering the resolution of the virtual signal corresponding to the broken line 421 to the resolution RS₂, and applies the cut-off frequency CUT₂ to the signals G1, R1 and B1 within the image region 442. Thus, the variable LPFs 71G, 71R and 71B perform the low-pass filtering process with the cut-off frequency CUT₂ on the signals G1, R1 and B1 within the image region 442. The signals after this low-pass filtering process are output as signals G2, R2 and B2 within the image region 442 in the target focused image.

It is possible to prepare in advance table data or a computing equation that defines a relationship between the resolution after the low-pass filtering process and the cut-off frequency of the low pass filter, and to determine the cut-off frequency to be set in the variable LPF portion 71 by using the table data or the computing equation. The table data or the computing equation defines that the cut-off frequencies corresponding to the resolutions RS₁ and RS₂ are CUT₁ and CUT₂, respectively.

As illustrated in FIG. 21, if the subject distance D₁ is within the depth of field of the target focused image while the subject distance D₂ is outside the depth of field of the target focused image, the cut-off frequencies CUT₁ and CUT₂ are set so that “CUT₁>CUT₂” holds. In this case, an image within the image region 442 is made blur by the variable LPF portion 71 compared with an image within the image region 441. As a result, resolution of the image within the image region 442 becomes lower than that within the image region 441 in the target focused image. In addition, unlike the situation illustrated in FIG. 21, also in the case where “D_{MAX}<D₁<D₂” holds, the cut-off frequencies CUT₁ and CUT₂ are set so that “CUT₁>CUT₂” holds. However, since the subject distances D₁ and D₂ are not within the specified depth of field, both images within the image regions 441 and 442 in the intermediate image are made blur by the variable LPF portion 71. However, degree of the blur is larger within the image region 442 than within the image region 441. As a result, resolution of the image within the image region 442 becomes lower than that within the image region 441 in the target focused image.

When this low-pass filtering process is performed on the entire image region of the intermediate image, the color signals G2, R2 and B2 at each pixel position of the target focused image are output from the variable LPF portion 71. As described above, subject distance dependencies of resolutions of the color signals G2, R2 and B2 are indicated by the curve 430 illustrated in FIG. 12D. The cut-off frequency defined by the cut-off frequency controller 72 is for converting the resolution characteristics of the virtual signal (421) into the resolution characteristics of the depth of field curve 420. In contrast, the resolution characteristics of the actual color signals G1, R1 and B1 are different from that of the virtual signal. Therefore, the curve 430 is a little different from the depth of field curve 420.

### FIRST VARIATION EXAMPLE

In the method described above, the process for generating the target focused image from the original image is realized by the complement process of high frequency components and the low-pass filtering process. However, it is possible to generate the intermediate image from the original image by using a point spread function (hereinafter referred to as PSF) when an image blur due to axial chromatic aberration is regarded as an image deterioration, and afterward to generate the target focused image. This method will be described as a first variation example.

The original image can be regarded as an image deteriorated by axial chromatic aberration. The deterioration here means an image blur due to axial chromatic aberration. A function or a spatial filter indicating the deterioration process is referred to as the PSF. When the subject distance is determined, the PSF for each color signal is determined. Therefore, based on the estimated subject distance at each position in the original image included in the subject distance information DIST, the PSF for each color signal at each position in the original image is determined. A convolution operation using the inverse function of the PSF is performed on the color signals G0, R0 and B0, so that deterioration (blur) of the original image due to axial chromatic aberration can be removed. The image processing of removing deterioration is also referred to as an image restoration process. The obtained image after the removal process is the intermediate image in the first variation example.

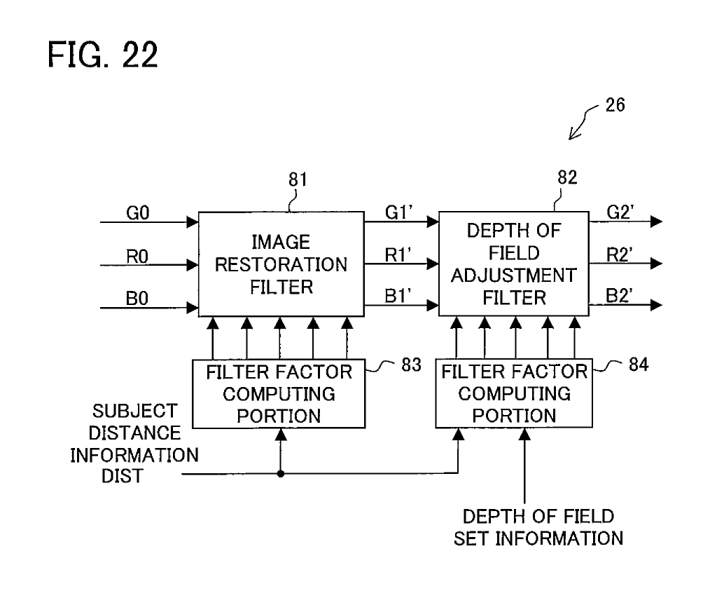

FIG. 22 is an internal block diagram of a depth of field adjustment portion 26 according to the first variation example. The expansion processing portion 16 and the depth of field control portion 17 in FIG. 11 can be replaced with the depth of field adjustment portion 26. The G, R and B signals of the intermediate image generated by the depth of field adjustment portion 26 are denoted by G1′, R1′ and B1′, respectively. The G, R and B signals of the target focused image generated by the depth of field adjustment portion 26 are denoted by G2′, R2′ and B2′, respectively. In the first variation example, the color signals G2′, R2′ and B2′ are supplied to the display controller 25 as the color signals G2, R2 and B2 of the target focused image.

An image restoration filter 81 in FIG. 22 is a two-dimensional spatial filter for causing the above-mentioned inverse function to act on the signals G0, R0 and B0. The image restoration filter 81 corresponds to an inverse filter of the PSF indicating a deterioration process of the original image due to axial chromatic aberration. A filter factor computing portion 83 determines the inverse filter of the PSF for the color signals G0, R0 and B0 at each position in the original image from the subject distance information DIST, and computes the filter factor of the image restoration filter 81 so that the determined inverse function acts on the signals G0, R0 and B0. The image restoration filter 81 uses the filter factor calculated by the filter factor computing portion 83 for performing the filtering process separately on the color signals G0, R0 and B0, so as to generate the color signals G1′, R1′ and B1′.

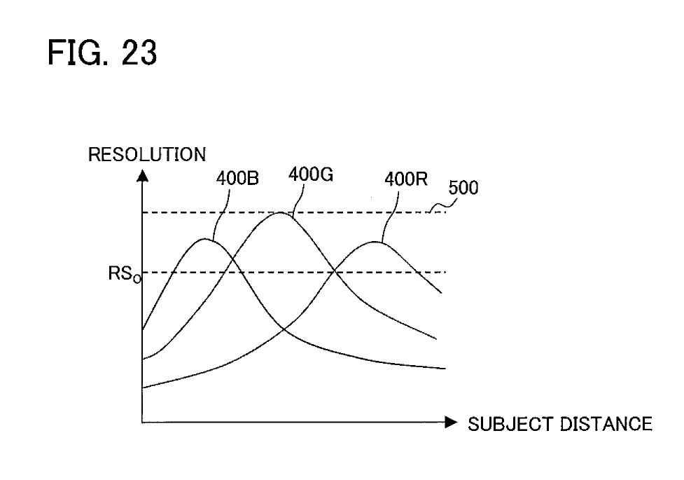

A broken line 500 in FIG. 23 indicates the subject distance dependencies of the resolutions of the color signals G1′, R1′ and B1′. The curves 400G, 400R and 400B indicate subject distance dependencies of the resolutions of the color signals G0, R0 and B0 as described above. By the image restoration process for each color signal, the intermediate image having high resolution in all the G, R and B signals can be obtained.

A depth of field adjustment filter 82 is also a two-dimensional spatial filter. The depth of field adjustment filter 82 filters the color signals G1′, R1′ and B1′ for each color signal, so as to generate the color signals G2′, R2′ and B2′ indicating the target focused image. A filter factor of a spatial filter as the depth of field adjustment filter 82 is computed by a filter factor computing portion 84.

The depth of field curve 420 as illustrated in FIG. 20 or 21 is set by the depth of field set information. The color signals G1′, R1′ and B1′ corresponding to the broken line 500 in FIG. 23 is equivalent to the above-mentioned virtual signal corresponding to the broken line 421 in FIG. 20 or 21. The depth of field adjustment filter 82 filters the color signals G1′, R1′ and B1′ so that the curve indicating subject distance dependencies of the resolutions of the color signals G2′, R2′ and B2′ corresponds to the depth of field curve 420.

A filter factor of the depth of field adjustment filter 82 for realizing this filtering process is computed by the filter factor computing portion 84 based on the depth of field set information and the subject distance information DIST.

Note that it is possible to replace the depth of field adjustment filter 82 and the filter factor computing portion 84 in the depth of field adjustment portion 26 illustrated in FIG. 22 with the variable LPF portion 71 and the cut-off frequency controller 72 illustrated in FIG. 19, and to perform the low-pass filtering process on the color signals G1′, R1′ and B1′ by using the variable LPF portion 71 and the cut-off frequency controller 72 so that the color signals G2′, R2′ and B2′ are generated. In this case, too, the cut-off frequency of the variable LPF portion 71 should be determined based on the depth of field set information and the subject distance information DIST as described above (see FIG. 19).

### SECOND VARIATION EXAMPLE

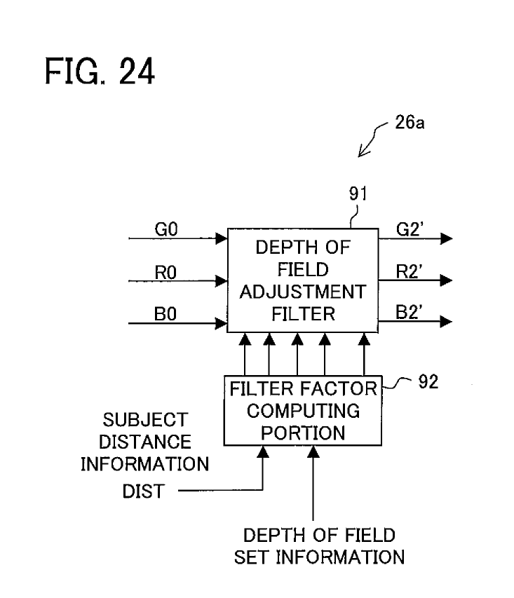

In addition, the filtering process for obtaining the target focused image is performed after the filtering process for obtaining the intermediate image in the structure of FIG. 22. However, it is possible to perform both the filtering processes simultaneously. In other words, the depth of field adjustment portion 26 may be configured like a depth of field adjustment portion 26a illustrated in FIG. 24. FIG. 24 is an internal block diagram of the depth of field adjustment portion 26a. The method of using the depth of field adjustment portion 26a is referred to as a second variation example. In the second variation example, the depth of field adjustment portion 26a is used as the depth of field adjustment portion 26. The depth of field adjustment portion 26a includes a depth of field adjustment filter 91 and a filter factor computing portion 92.

The depth of field adjustment filter 91 is a two-dimensional spatial filter for performing a filtering process in which the filtering by the image restoration filter 81 and the filtering by the depth of field adjustment filter 82 of FIG. 22 are integrated. The filtering process by the depth of field adjustment filter 91 is performed on the color signals G0′, R0′ and B0′ of the original image for each color signal, so that the color signals G2′, R2′ and B2′ are generated directly. In the second variation example, the color signals G2′, R2′ and B2′ generated by the depth of field adjustment portion 26a are supplied to the display controller 25 as the color signals G2, R2 and B2 of the target focused image.

The filter factor computing portion 92 is a filter factor computing portion in which the filter factor computing portions 83 and 84 of FIG. 22 are integrated. The filter factor computing portion 92 computes the filter factor of the depth of field adjustment filter 91 for each color signal from the subject distance information DIST and the depth of field set information.

### VARIATIONS

The specified values shown in the above description are merely examples. As a matter of course, the values can be changed variously. As variation examples or annotations of the embodiment described above, Notes 1 to 4 will be described below. Contents of the individual Notes can be combined arbitrarily as long as no contradiction arises.

[Note 1]

In the first embodiment, the subject distance detection portion 103 of FIG. 1 detects the subject distance based on the image data, but is it possible to detect the subject distance based on other data except the image data.

For instance, it is possible to use a stereo camera for detecting the subject distance. In other words, the image taking portion 101 may be used as a first camera portion, and a second camera portion (not shown) similar to the first camera portion may be provided to the image sensing apparatus 100, so that the subject distance can be detected base on a pair of original images obtained by using the first and the second camera portions. As known well, the first camera portion and the second camera portion constituting the stereo camera are disposed at different positions, and the subject distance at each pixel position (x, y) can be detected based on image information difference between the original image obtained from the first camera portion and the original image obtained from the second camera portion (i.e., based on parallax (disparity)).

In addition, for example, it is possible to provide a distance sensor (not shown) for measuring the subject distance to the image sensing apparatus 100, and to detect the subject distance of each pixel position (x, y) based on a result of measurement by the distance sensor. The distance sensor, for example, projects light toward the photographing direction of the image sensing apparatus 100 and measured time until the projected light returns after being reflected by the subject. The subject distance can be detected based on the measured time, and the subject distance at each pixel position (x, y) can be detected by changing the light projection direction.

[Note 2]

In the embodiment described above, the function of generating the target focused image and the emphasis display image from the original image so as to perform display control of the emphasis display image is realized in the image sensing apparatus (1 or 100), but the function may be realized by an image display apparatus (not shown) disposed outside the image sensing apparatus.

For instance, the portions denoted by numerals 103 to 106 illustrated in FIG. 1 may be disposed in the external image display apparatus. Alternatively, for example, the portions denoted by numerals 15 to 25 illustrated in FIG. 11 may be disposed in the external image display apparatus. Still alternatively, the portions denoted by numerals 15 and 18 to 25 illustrated in FIG. 11 and the depth of field adjustment portion 26 or 26a illustrated in FIG. 22 or 24 may be disposed in the external image display apparatus. Then, image data of the original image (e.g., color signals G0, R0 and B0) obtained by photographing with the image sensing apparatus (1 or 100) is supplied to the external image display apparatus, so that generation of the target focused image and the emphasis display image, and display of the emphasis display image are performed in the external image display apparatus.

[Note 3]

The image sensing apparatus (1 or 100) can be realized by combination of hardware or by combination of hardware and software. In particular, the entire or a part of the function of generating the target focused image and the emphasis display image from the original image can be realized by hardware, software or by combination of hardware and software. When the image sensing apparatus (1 or 100) is constituted of software, a block diagram of the part that is realized by software indicates a function block diagram of the part.

[Note 4]

It can be considered that each of the image sensing apparatus 100 according to the first embodiment and the image sensing apparatus 1 according to the second embodiment includes the image obtaining portion for obtaining the image data containing the subject distance information. In the image sensing apparatus 100, the image obtaining portion is adapted to includes the image taking portion 101 and may further include the original image generating portion 102 as an element (see FIG. 1 or 25). In the image sensing apparatus 1, the image obtaining portion is adapted to include the image sensor 11 and may further include the AFE 12 and/or the demosaicing processing portion 14 as elements (see FIG. 11).

As described above in the first embodiment, the emphasis display image is generated by the display controller 105 from the target focused image generated by the target focused image generating portion 104, and the emphasis display image is displayed on the display portion 106. However, it is possible that the display controller 105 controls the display portion 106 to display the target focused image itself. In this case, the portion including the target focused image generating portion 104 and the display controller 105 functions as an image generation and display controller portion that generates the emphasis display image based on the target focused image or the target focused image and controls the display portion 106 to display.

In the second embodiment, the display controller 25 can also control the LCD 19 to display the target focused image itself expressed by the signals G2, R2 and B2 (see FIG. 11). In this case, the portion including the expansion processing portion 16, the depth of field control portion 17 and the display controller 25 functions as the image generation and display controller portion that generates the emphasis display image based on the target focused image or the target focused image and controls the LCD 19 to display.

What is claimed is:

1. An image display apparatus, comprising:
a subject distance detection portion which detects a subject distance of each subject whose image is taken by an image taking portion;
an output image generating portion which generates an image in which a subject positioned within a specific distance range is in focus as an output image from an input image taken by the image taking portion; and
a display controller which extracts an in-focus region that is an image region in the output image in which region the subject positioned within the specific distance range appears based on a result of the detection by the subject distance detection portion, and controls a display portion to display a display image based on the output image so that the in-focus region can be visually distinguished.

2. The image display apparatus according to claim 1, wherein
the subject distance detection portion detects a subject distance of a subject at each position on the input image based on image data of the input image and characteristics of an optical system of the image taking portion, and
the output image generating portion receives designation of the specific distance range, and performs image processing on the input image corresponding to the subject distance detected by the subject distance detection portion, the designated specific distance range, and the characteristics of the optical system of the image taking portion so as to generate the output image.

3. The image display apparatus according to claim 2, wherein
the image data of the input image contains information based on the subject distance of the subject at each position on the input image, and
the subject distance detection portion extracts the information from the image data of the input image, and detects the subject distance of the subject at each position on the input image based on a result of the extraction and the characteristics of the optical system.

4. The image display apparatus according to claim 2, wherein
the subject distance detection portion extracts, for each color signal, a predetermined high frequency component contained in color signals of a plurality of colors representing the input image, and detects the subject distance of the subject at each position on the input image based on a result of the extraction and characteristics of axial chromatic aberration of the optical system.

5. An image sensing apparatus comprising:
an image taking portion; and
the image display apparatus according to claim 1.

6. An image sensing apparatus comprising:
an image taking portion; and
the image display apparatus according to claim 2, wherein
image data obtained by imaging with the image taking portion is supplied to the image display apparatus as the image data of the input image, and
after taking the input image, the output image is generated from the input image in accordance with an operation of designating the specific distance range, so that the display image based on the output image is displayed on the display portion.

7. An image display apparatus comprising:
an image obtaining portion which obtains image data of an input image that is image data containing subject distance information based on a subject distance of each subject;
a specific subject distance input portion which receives an input of a specific subject distance; and
an image generation and display controller portion which generates an output image in which a subject positioned at the specific subject distance is in focus by performing image processing on the input image based on the subject distance information, and controls a display portion to display the output image or an image based on the output image.

8. The image display apparatus according to claim 7, wherein
the image generation and display controller portion specifies the subject that is in focus in the output image, and controls the display portion to display with emphasis on the subject that is in focus.

9. An image sensing apparatus comprising:
an image taking portion; and
the image display apparatus according to claim 7.
